(19) United States
(12) Patent Application Publication
(10) Pub. No.: US 2014/0283702 A1
(43) Pub. Date: Sep. 25, 2014

(54) LITHOGRAPHIC PRINTING PLATE SUPPORT AND NEGATIVE PHOTOSENSITIVE LITHOGRAPHIC PRINTING PLATE

(71) Applicant: MITSUBISHI PAPER MILLS LIMITED, Tokyo (JP)

(72) Inventors: Daisuke Doi, Tokyo (JP); Yukio Okamoto, Tokyo (JP); Koichi Agata, Tokyo (JP); Yukinao Kawamata, Tokyo (JP)

(21) Appl. No.: 14/350,145

(22) PCT Filed: Oct. 12, 2012
(86) PCT No.: PCT/JP2012/076516

§ 371 Date: Apr. 7, 2014

(30) Foreign Application Priority Data
Oct. 19, 2011 (JP) 2011-229981
Dec. 21, 2011 (JP) 2011-279848
Mar. 16, 2012 (JP) 2012-060070
Aug. 13, 2012 (JP) 2012-179454
Aug. 21, 2012 (JP) 2012-182557
Sep. 13, 2012 (JP) 2012-201211

(51) Int. Cl. B41N 1/14

(52) U.S. Cl. CPC B41N 1/14
USPC 101/454

(57) ABSTRACT

The invention provides lithographic printing plate supports that can give lithographic printing plates excellent in all of plate durability, scumming resistance, ink releasability and halftone staining resistance, and also provides such negative photosensitive lithographic printing plates. The lithographic printing plate support includes a hydrophilic layer containing an inorganic filler, the inorganic filler having particle size distribution peaks in the range of 0.2 μm to less than 0.6 μm and in the range of 0.6 μm to less than 1.5 μm. The negative photosensitive lithographic printing plate includes the support.

### TECHNICAL FIELD

The present invention relates to a lithographic printing plate support having at least a hydrophilic layer on a substrate, and to a negative photosensitive lithographic printing plate including the lithographic printing plate support. In detail, the invention relates to a lithographic printing plate support suited for a lithographic printing plate that is developed by chemical-less development involving substantially no alkaline agents, and to such a negative photosensitive lithographic printing plate.

### BACKGROUND ART

In recent years, the broadened implementation of JDF (job definition format) has led to full digitalization of CTP (computer to plate) and thus to significant improvements in work efficiency. Further, hard aspects such as output equipment and printing plates have come to be applied to process-less or chemical-less techniques. This has not only enhanced the efficiency but also resulted in the pervaded concept of manufacturing with consideration for human health and environment. However, the current mainstream thermal or photopolymer CTP printing plates are not adequately chemical-less because the printing plates are manufactured by a series of steps in which the plates are photoexposed with a laser, then non-image areas are dissolved and removed with a developer containing a strong alkaline agent, and the developed plates are washed with water and gummed.

To avoid the use of such developers containing a strong alkaline agent, negative photosensitive lithographic printing plates have been proposed which can be developed with a mild developer such as water. For example, Japanese Patent Application Kokai Publication No. 2003-215801 (Patent Literature 1) discloses a negative photosensitive lithographic printing plate which includes a hydrophilic layer on a plastic film support and a photosensitive layer on the hydrophilic layer, wherein the photosensitive layer contains a cationic water-soluble polymer having vinyl-substituted phenyl groups in side chains, or a water-soluble polymer having vinyl-substituted phenyl groups and sulfonate salt groups in side chains, as well as a photopolymerization initiator or an acid generator.

Examples of the hydrophilic layers disclosed in the above patent literature include hydrophilic resin layers described in Japanese Patent Publication No. S49-2286 which are formed of hydroxyalkyl group-containing (meth)acrylate polymers, hydrophilic layers described in Japanese Patent Publication No. S56-2938 which are formed of urea resins and pigments, hydrophilic layers described in Japanese Patent Application Kokai Publication No. S48-83902 which are obtained by curing acrylamide polymers with aldehydes, hydrophilic layers described in Japanese Patent Application Kokai Publication No. S62-280766 which are obtained by curing compositions containing a water-soluble melamine resin, a polyvinyl alcohol and a water-insoluble inorganic powder, hydrophilic layers described in Japanese Patent Application Kokai Publication No. H8-184967 which are obtained by curing water-soluble polymers including repeating units with an amidino group in a side chain, hydrophilic layers described in Japanese Patent Application Kokai Publication No. H8-272087 which include hydrophilic (co)polymers and have been cured with a hydrolyzed tetraalkyl orthosilicate, hydrophilic layers with an onium group described in Japanese Patent Application Kokai Publication No. H10-296895, hydrophilic layers described in Japanese Patent Application Kokai Publication No. H11-311861 which include crosslinked hydrophilic polymers having a Lewis base moiety that have been three-dimensionally crosslinked via interaction with polyvalent metal ions, and hydrophilic layers described in Japanese Patent Application Kokai Publication No. 2000-122269 which contain hydrophilic resins and water-dispersible fillers. However, it is difficult to obtain sufficient plate durability and stain resistance when these hydrophilic layers are combined with the aforementioned photosensitive layers containing a cationic water-soluble polymer or a water-soluble polymer with a sulfonate salt group.

To solve such problems, Japanese Patent Application Kokai Publication No. 2008-265297 (Patent Literature 2) discloses a negative photosensitive lithographic printing plate that has a hydrophilic layer on a support which contains a water-soluble polymer, a crosslinking agent for the crosslinking of the water-soluble polymer, and a colloidal silica, with a specific ratio between the water-soluble polymer and the colloidal silica. Further, Japanese Patent Application Kokai Publication No. 2009-226596 (Patent Literature 3) discloses a negative photosensitive lithographic printing plate in which a hydrophilic layer contains at least a water-soluble polymer and inorganic fine particles, and the surface pH value of the hydrophilic layer is not less than 7.0.

To improve the stain resistance of negative photosensitive lithographic printing plates that can be developed with a mild developer such as water, for example, Japanese Patent Application Kokai Publications Nos. 2010-237559 (Patent Literature 4), 2010-231133 (Patent Literature 5) and 2010-224188 (Patent Literature 6) disclose that an intermediate layer is disposed between a support and a hydrophilic layer.

On the other hand, Japanese Patent Application Kokai Publication No. 2000-199964 (Patent Literature 7) discloses a lithographic printing plate support with excellent stain resistance which has a hydrophilic layer containing porous inorganic particles, and two or more kinds of metal oxide fine particles having different average particle diameters. Japanese Patent Application Kokai Publication No. 2000-229485 (Patent Literature 8) discloses a printing plate support with excellent plate durability and stain resistance which has a hydrophilic layer containing porous inorganic particles or inorganic scale particles. Japanese Patent Application Kokai Publication No. 2002-19315 (Patent Literature 9) discloses a lithographic printing plate support which has a hydrophilic layer containing particles having different average particle diameters and an identical chemical composition; in detail, a combination of a colloidal silica with an average particle diameter of 1 to 10 nm and a porous silica with an average particle diameter of 0.2 to 10 μm is described as a specific example. Japanese Patent Application Kokai Publication No. 2003-231374 (Patent Literature 10) discloses a printing plate material in which a hydrophilic layer having a specific surface shape is disposed on a substrate; in detail, a combination of metal oxide fine particles having an average particle diameter of 3 to 100 nm and porous metal oxide particles having an average particle diameter of not less than 1 μm is described as a specific example.

### CITATION LIST

### Patent Literature

Patent Literature 1: Japanese Patent Application Kokai Publication No. 2003-215801
Patent Literature 2: Japanese Patent Application Kokai Publication No. 2008-265297
Patent Literature 3: Japanese Patent Application Kokai Publication No. 2009-226596
Patent Literature 4: Japanese Patent Application Kokai Publication No. 2010-237559
Patent Literature 5: Japanese Patent Application Kokai Publication No. 2010-231133
Patent Literature 6: Japanese Patent Application Kokai Publication No. 2010-224188
Patent Literature 7: Japanese Patent Application Kokai Publication No. 2000-199964
Patent Literature 8: Japanese Patent Application Kokai Publication No. 2000-229485
Patent Literature 9: Japanese Patent Application Kokai Publication No. 2002-19315
Patent Literature 10: Japanese Patent Application Kokai Publication No. 2003-231374

### DISCLOSURE OF THE INVENTION

### Technical Problem

Development with a mild developer such as water became possible with the negative photosensitive lithographic printing plates described in Patent Literatures 2 and 3. However, these lithographic printing plates cause a phenomenon called filling in of halftones in which shadows are stained depending on the printing conditions, or often exhibit insufficient plate durability to suffer local missing of image areas, thus requiring improvement. The negative photosensitive lithographic printing plates described in Patent Literatures 4 to 6 are not fully satisfactory in terms of performance. The lithographic printing plate supports and the negative photosensitive lithographic printing plates according to Patent Literatures 7 to 10 do not satisfy all of plate durability, scumming resistance, halftone staining resistance and ink releasability, thus requiring improvement.

An object of the invention is to provide lithographic printing plate supports that can give lithographic printing plates excellent in all of plate durability, scumming resistance, ink releasability and halftone staining resistance. Another object of the invention is to provide negative photosensitive lithographic printing plates excellent in all of plate durability, scumming resistance, ink releasability and halftone staining resistance.

### Solution to Problem

The objects of the invention are basically achieved by the following configurations of the invention.

1) A lithographic printing plate support including a hydrophilic layer on a substrate, the hydrophilic layer containing an inorganic filler and a hydrophilic binder, the inorganic filler in the hydrophilic layer having particle size distribution peaks in the range of 0.2 μm to less than 0.6 μm and in the range of 0.6 μm to less than 1.5 μm.

2) A negative photosensitive lithographic printing plate including at least a photopolymerizable photosensitive layer on the hydrophilic layer of the lithographic printing plate support described in (1).

### Advantageous Effects of the Invention

The lithographic printing plate supports of the invention can give lithographic printing plates excellent in all of plate durability, scumming resistance, ink releasability and halftone staining resistance. The negative photosensitive lithographic printing plates of the invention are excellent in all of plate durability, scumming resistance, ink releasability and halftone staining resistance.

### BEST MODE FOR CARRYING OUT THE INVENTION

Hereinbelow, the present invention will be described in detail.

[symbol] Substrates

[symbol]

Examples of the substrates in the inventive lithographic printing plate supports include aluminum plates, various plastic films, and papers laminated with various plastics. Of these, various plastic films having flexibility and a small tensile deformation are preferably used. Preferred typical examples of the plastic film substrates include polyethylene terephthalate, polyethylene naphthalate, polyethylene, polypropylene, polystyrene, polyvinyl acetal, polycarbonate, cellulose diacetate, cellulose triacetate, cellulose propionate, cellulose butyrate and cellulose nitrate. In particular, polyethylene terephthalate and polyethylene naphthalate are preferably used.

The substrates may be surface-treated to allow the surface to achieve higher adhesion with respect to the hydrophilic layer or an optional back coat layer. Examples of the surface treatments include corona discharge treatment, flame treatment, plasma treatment and UV irradiation treatment. Further, the surface treatment may be performed by forming an undercoat layer on the substrate to increase the adhesion with respect to the hydrophilic layer disposed on the substrate.

[symbol] Hydrophilic layers

[symbol]

The lithographic printing plate support of the invention has a hydrophilic layer on the substrate. The hydrophilic layer contains at least an inorganic filler and a hydrophilic binder. The inorganic filler in the hydrophilic layer has at least two particle size distribution peaks, one in the range of 0.2 μm to less than 0.6 μm and the other in the range of 0.6 μm to less than 1.5 μm. It is preferable that the fx/fy ratio be not less than 1.5 wherein fx is the distribution frequency of the inorganic filler in the range of 0.2 μm to less than 0.6 μm and fy is the distribution frequency of the inorganic filler in the range of 0.6 μm to less than 1.5 μm, as well as that the distribution frequency fy be not less than 25%. The fx/fy ratio is more preferably not less than 2.0. The upper limit is desirably less than 3.5. When a plurality of peaks are present in the above range, for example, in the range of 0.2 μm to less than 0.6 μm, the distribution frequency fx may be obtained based on the highest peak. In the case, however, where two peaks are adjacent so closely to each other that the height of the valley between the two peaks is 60% or more of the height of the higher peak, such peaks are regarded as a single peak in the invention. With the above configuration, lithographic printing plate supports are obtained which exhibit markedly excellent plate durability and scumming resistance when fabricated into printing plates.

The particle size distribution in the invention is a volumetric particle size distribution, and indicates the proportions of particle diameters of the sample particles that are analyzed. This property may be measured by a generally known method. Examples of the known measurement methods include sieving methods, Coulter methods (the Coulter principle), dynamic light scattering methods, image analysis methods, and laser diffraction scattering methods. In the invention, laser diffraction scattering methods are preferably used from such viewpoints as the size of particles measured, reproducibility and operation properties. For example, the particle size distribution may be measured with LA-920 (a laser diffraction/scattering particle size distribution analyzer) manufactured by HORIBA, Ltd. The distribution frequencies may be obtained based on the measurement results by distributing the measurement results into proportions of respective sizes (particle diameters).

The particle size distribution and the distribution frequencies in the invention may be obtained by analyzing the inorganic filler dispersed in a coating liquid, or by dissolving a dry film of hydrophilic layer into an alkali and analyzing the inorganic filler in the solution. The invention may involve two or more types of inorganic fillers as will be described later. Because a laser diffraction scattering method, which is preferably used in the invention, determines a light intensity distribution pattern based on the Fraunhofer diffraction theory and the Mie scattering theory, a refractive index that is specific to the subject is necessary. Thus, it is difficult with this method to determine accurately the particle size distribution and the distribution frequencies with respect to a coating liquid that contains two or more types of inorganic fillers having different refractive indexes. In such cases where the coating liquid contains two or more types of inorganic fillers, however, the particle size distribution and the distribution frequencies may be obtained by separately measuring beforehand the particle size distributions and the distribution frequencies of the individual inorganic fillers, and then multiplying the obtained measurement results by coefficients which are the ratios of the fillers in the coating liquid.

A single or two or more types of the inorganic fillers having the above particle size distribution may be used in the hydrophilic layer. The combined use of two or more types of such inorganic fillers is preferable because the aforementioned particle size distribution may be obtained relatively easily. In particular, it is preferable to use an inorganic filler having an average primary particle diameter of 0.1 μm to less than 0.6 μm in combination with an inorganic filler having an average primary particle diameter of 0.6 μm to less than 2.0 μm. As long as this combination is satisfied, a larger number of inorganic fillers, for example, three or four types, may be used in combination. The amount of the inorganic fillers added is preferably not less than 60 mass %, and more preferably not less than 70 mass % relative to the total solid content of the hydrophilic layer.

Examples of the inorganic fillers used in the hydrophilic layer include calcium carbonate, magnesium carbonate, zinc oxide, titanium dioxide, barium sulfate, aluminum hydroxide, zinc hydroxide, colloidal silica, porous silica and kaolin. Of these, titanium dioxide, barium sulfate and aluminum hydroxide are preferred. More preferably, two or more, and particularly preferably all of these three types of inorganic fillers, namely, titanium dioxide, barium sulfate and aluminum hydroxide are used in combination. Further, the use of silicon-containing compounds such as colloidal silica, porous silica and kaolin is preferably avoided. It is preferable to control the content of these silicon-containing compounds to not more than 5 mass %, more preferably not more than 3 mass %, particularly preferably not more than 1 mass %, and further preferably not more than 0.5 mass % relative to all the inorganic fillers in the hydrophilic layer.

Titanium dioxide which is a preferred inorganic filler may be rutile or anatase, and the production process is not limited to the sulfuric acid process or the chlorine process. These forms of titanium dioxide may be used singly or as a mixture. From the viewpoints of dispersion stability and other functions, various surface-treated products may be selectively used. Examples of commercially available titanium dioxides include those sold under the trade names of SR-1, R-650, R-5N, R-7E, R-3L, A-110 and A-190 manufactured by SAKAI CHEMICAL INDUSTRY CO., LTD., TIPAQUE series R-580, R-930, A-100, A-220 and CR-58 manufactured by ISHIHARA SANGYO KAISHA, LTD., KRONOS series KR-310, KR-380, KA-10 and KA-20 manufactured by Titan Kogyo, Ltd., TITANIX series JR-301, JR-600A, JR-800 and JR-701 manufactured by TAYCA CORPORATION, and Ti-Pure series R-900 and R-931 manufactured by Du Pont Kabushiki Kaisha.

Barium sulfate is preferably precipitated barium sulfate that is prepared by chemical precipitation involving the addition of an aqueous sulfate salt solution to a barium chloride solution. For example, precipitated barium sulfates are commercially available with various particle diameters and surface treatments under the trade name “BARIACE” from SAKAI CHEMICAL INDUSTRY CO., LTD. Any of such products may be used in the invention.

Aluminum hydroxide may be obtained by a process in which bauxite, an alumina-containing ore, is mixed with a caustic soda or sodium aluminate solution, the mixture is then treated at a high temperature and a high pressure to extract the alumina component, thereafter the red mud that is the undissolved residue is separated and removed from the extract solution thereby obtaining a clarified sodium aluminate solution, and a seed is added to the solution to cause the crystallization of aluminum hydroxide which is then crushed. Various grades of aluminum hydroxide are available from SHOWA DENKO K.K. under the trade name “HIGILITE”. Any of such products may be used in the invention.

The hydrophilic binder used in the hydrophilic layer of the invention may be any of natural products, semi-natural (semi-synthetic) products and synthetic products. Examples of the natural products include starches; algae derivatives such as seaweed mannan, agar and sodium alginate; plant mucilages such as mannan, pectin, tragacanth gum, karaya gum, xanthine gum, guar bean gum, locust bean gum and gum arabic; microbial mucilages, including homopolysaccharides such as dextran, glucan, xanthan gum and levans, and heteropolysaccharides such as succinoglucan, pullulan, curdlan and xanthan gum; proteins such as glue, gelatin, casein and collagen; and chitin and derivatives thereof. Examples of the semi-natural (semi-synthetic) products include cellulose derivatives; modified gums such as carboxymethyl guar gum; and processed starches such as roasted starches, oxidized starches and esterified starches of substances such as dextrin. Examples of the synthetic products include polyvinyl alcohol, modified polyvinyl alcohols such as partially acetalized polyvinyl alcohol, allyl-modified polyvinyl alcohol, polyvinyl methyl ether, polyvinyl ethyl ether and polyvinyl isobutyl ether; polyacrylic acid derivatives and polymethacrylic acid derivatives such as polyacrylate salts, partially saponified polyacrylate esters, polymethacrylate salts and polyacrylamides; polyethylene glycol, polyethylene oxide, polyvinylpyrrolidone, vinylpyrrolidone/vinyl acetate copolymer, carboxyvinyl polymer, styrene/maleic acid copolymer and styrene/crotonic acid copolymer. Of these, gelatin is preferably used.

More preferably, gelatin has an eluting protein content of not more than 2.5 mass % and a jelly strength of not less than 200 g. Particularly preferably, the eluting protein content is not more than 2.0 mass % and/or the jelly strength is not less than 225 g, in which case the balance of printing suitability is advantageously satisfied at a higher level. The eluting protein content and the jelly strength in the invention may be determined by the measurement methods specified in “PAGI METHOD, METHODS FOR TESTING PHOTOGRAPHIC GELATIN, Tenth Edition, November 2006, COMMISSION ON METHODS FOR TESTING PHOTOGRAPHIC GELATIN”.

Gelatins which are preferably used in the invention will be described in further detail. For example, lime-treated gelatin is produced as follows. First, ossein which consists solely of collagen cleaned of calcium phosphate is soaked in saturated limewater (lime soaked) for 2 to 3 months, then washed with water, neutralized, and extracted with hot water at about 60° C. (first extraction). Subsequently, the second, third and fourth extractions are performed at about 70° C., about 85° C. and 95° C., respectively. Each extract is filtered, concentrated under reduced pressure, cooled at about 10° C. and solidified, followed by drying to produce gelatin.

In the above case, ossein is pretreated (alkali treated) with limewater. The pretreatment may be performed by other methods such as an acid treatment in which ossein is soaked in a dilute solution of an acid such as hydrochloric acid or sulfuric acid for a short time (10 to 48 hours), and an enzyme treatment which utilizes an enzyme such as pronase or pepsin. Although the extractions in the above process start with the first extraction at 60° C. and end with the fourth extraction at 95° C., the first extraction may be generally started at a temperature of not less than 45° C. The number of extractions, which is four times in the above case, may be increased to, for example, seven times by reducing the difference in extraction temperature from the previous stage. Gelatins generally available in the market are mixtures containing appropriate proportions of dried gelatins produced through several extraction stages, in accordance with desired physical and chemical properties.

In order to ensure that the gelatin will have an eluting protein content of not more than 2.5 mass % and a jelly strength of not less than 200 g, it is preferable to use bone gelatin which is obtained from ossein extracted from beef bone as the raw material. The gelatin is preferably one which is obtained through an alkali treatment or an enzyme treatment as the pretreatment. Gelatin fractions obtained from the first and second extractions are preferable because particularly high jelly strength may be obtained.

The amount of gelatin used in the hydrophilic layer is preferably in the range of 0.5 to 2.0 g/m², and more preferably in the range of 0.8 to 1.5 g/m² in terms of solid content.

When the above-described gelatin is used as the hydrophilic binder in the hydrophilic layer, the invention may involve another hydrophilic binder in combination therewith. Such an additional hydrophilic binder is preferably used in an amount of 0 to 10 mass %, and more preferably 0 to 5 mass % relative to the total mass of the hydrophilic binders present in the hydrophilic layer.

The content of the hydrophilic binder in the hydrophilic layer has a preferred ratio to the content of the inorganic fillers. That is, the ratio is preferably 5 to 30 mass %, and more preferably 10 to 25 mass % relative to 100 parts by mass of the total of the inorganic fillers. When the ratio is not more than 30 mass %, the filler packing density is high enough to impart sufficient hydrophilicity and thus sufficient scumming resistance and halftone staining resistance may be obtained. On the other hand, the ratio being not less than 5 mass % ensures that the coating liquid will exhibit good handling properties and the formed hydrophilic layer will not have cracks.

The hydrophilic layer in the invention preferably contains a crosslinking agent. Examples of the crosslinking agents which may be suitably used include melamine resins, polyisocyanate compounds, aldehyde compounds, silane compounds, chromium alum and divinyl sulfone. When the hydrophilic binder is gelatin, divinyl sulfone is particularly preferable for use as the crosslinking agent. The amount of the crosslinking agent is preferably 5 to 35 mass %, and more preferably 10 to 25 mass % relative to the solid content of the hydrophilic binder. The crosslinking agents may be added in any manner without limitation. For example, the crosslinking agents may be added during the production of the coating liquid for the hydrophilic layer, or may be added in-line immediately before the application.

To ensure that the hydrophilic layer is sufficiently crosslinked, for example, it is preferable that the formed hydrophilic layer be subjected to a heat treatment at 30 to 60° C., preferably 40 to 50° C. for 0.5 to 10 days, preferably 1 to 7 days before a photopolymerizable photosensitive layer is formed thereon. This heat treatment allows the hydrophilic layer to exhibit sufficient performances not only in printing suitability but also in scratch resistance even when the hydrophilic layer is exposed by the development treatment after photoexposure and serves as non-image areas during printing.

The hydrophilic layer in the invention may contain known additives such as filler dispersants, surfactants, anti-foaming agents, viscosity stabilizers, pH adjustors, UV absorbers and antioxidants. The hydrophilic layer in the invention preferably contains a surfactant. Any surfactants may be used as long as the advantageous effects of the invention are not impaired. It is preferable to use polyoxyethylene alkyl ether acetate salts or amphoteric surfactants as a surfactant.

In the polyoxyethylene alkyl ether acetate salts, the alkyl ether moieties preferably have 8 or more carbon atoms. Linear alkyl ethers having 8 to 20 carbon atoms are particularly preferable. Examples of the salts include sodium salts and potassium salts. Examples of commercially available such compounds include those sold under the trade names of NIKKOL series ECT-3NEX, ECTD-3NEX, ECTD-6NEX and AKYPO-RLM45NV from NIKKO CHEMICALS CO., LTD., NEO-HITENOL ECL-45 from DAI-ICHI KOGYO SEIYAKU CO., LTD., KAO AKYPO RLM-45W and KAO AKYPO RLM-100W from Kao Corporation, and NJCOAP 2P45-S from New Japan Chemical Co., Ltd. These products may be appropriately purchased and used.

The amount of the polyoxyethylene alkyl ether acetate salt is preferably 0.5 to 20 mass %, and more preferably 2 to 10 mass % in terms of solid content relative to the hydrophilic polymer in the hydrophilic layer.

Examples of the amphoteric surfactants include fatty acid alkyl betaine amphoteric surfactants such as coconut oil fatty acid amidopropyl betaine, lauric acid amidopropyl betaine, myristic acid amidopropyl betaine and octanoic acid amidopropyl betaine; alkyl betaine amphoteric surfactants such as lauryldimethylaminoacetic acid betaine and stearyldimethylaminoacetic acid betaine; sulfobetaine amphoteric surfactants such as dodecyl aminomethyl dimethyl sulfopropyl betaine and octadecyl aminomethyl dimethyl sulfopropyl betaine; amino acid amphoteric surfactants such as sodium lauroyl glutamate, potassium lauroyl glutamate and lauroylmethyl-β-alanine; and amine oxide amphoteric surfactants such as lauryldimethylamine N-oxide and oleyldimethylamine N-oxide. As the amphoteric surfactants preferably used in the invention, fatty acid alkyl betaine surfactants and alkyl betaine surfactants are preferable, and fatty acid alkyl betaine surfactants are particularly preferable. These amphoteric surfactants are sold and available under the trade names of NIKKOL AM from NIKKO CHEMICALS CO., LTD., SOFTAZOLINE from Kawaken Fine Chemicals Co., Ltd., and AMOGEN from DAI-ICHI KOGYO SEIYAKU CO., LTD.

The amount of the amphoteric surfactant is preferably 0.2 to 15 mass %, and more preferably 1.5 to 10 mass % in terms of solid content relative to the hydrophilic binder in the hydrophilic layer.

The hydrophilic layer in the invention preferably contains a sugar alcohol. Sugar alcohols are polyhydroxyalkanes resulting from the reduction of aldoses or ketoses. The sugar alcohols used in the invention are preferably linear polyhydric alcohols. Such sugar alcohols may be represented by the general formula CₙH₂₍ₙ₊₁₎Oₙ. When n is 3, 4, 5, 6, 7, 8, 9 and 10, the compounds are named tritol, tetritol, pentitol, hexitol, heptitol, octitol, nonitol and decitol, respectively. Each sugar alcohol includes a number of stereoisomers in accordance with the number of asymmetric carbon atoms. In the invention, sugar alcohols with n=3 to 6 are preferably used. Specific examples of the sugar alcohols include sorbitol, mannitol, dulcitol, xylitol, erythritol and glycerol. Of these, sorbitol and xylitol are particularly preferable. The sugar alcohols may be used singly, or two or more may be used in combination.

Preferred embodiments of the methods for introducing the sugar alcohol into the hydrophilic layer will be discussed. The following approach, which is described as an example, is particularly preferable because the advantageous effects of the invention may be achieved to the greatest extent. The approach is to subject a dry film of sugar alcohol-free hydrophilic layer to a surface treatment. The surface treatment is performed by a method in which the surface of the hydrophilic layer (including the surface of voids if any present in the hydrophilic layer) is impregnated and coated with the sugar alcohol by a known coating technique such as dipping or fountain coating, by a combination of such a coating technique with a known remover such as air knife, or by spraying or blowing.

In the invention, the sugar alcohol is dissolved or dispersed in an aqueous medium to give a surface treatment agent which is used for the impregnation and coating in the surface treatment. The content of the sugar alcohol in the surface treatment agent is preferably not more than 10 mass %, and more preferably not more than 5 mass %. The lower limit is preferably 0.1 mass % or above, and more preferably 0.5 mass % or above. The surface treatment agent having such a low concentration can advantageously treat the hydrophilic layer uniformly.

The dry mass of the sugar alcohol in the hydrophilic layer subjected to the above surface treatment is preferably 10 to 300 mg, and more preferably in the range of 30 to 200 mg per 1 m².

The term aqueous medium in the surface treatment agent indicates that water represents at least 50 mass % or more, and preferably 80 mass % or more of the solvent components in the surface treatment agent. Examples of the solvents other than water include organic solvents highly miscible with water such as alcohols and glycols.

The surface treatment agent may appropriately contain additives such as surfactants, pH adjustors and anti-foaming agents. Further, the surface treatment agent may contain hydrophilic compounds, for example sugars, in addition to the compounds such as gelatins and polyvinyl alcohols for such purposes as viscosity control. The hydrophilic compounds are preferably used such that the content thereof in the surface treatment agent is not more than 5 mass %, and are particularly preferably used in not more than 20 mass %, and more preferably not more than 10 mass % relative to the sugar alcohol in the surface treatment agent.

Further, it is preferable that the hydrophilic layer in the invention be a hydrophilic layer that has been surface-treated with a polymer compound having a polymerizable double bond group.

The polymer compounds having a polymerizable double bond group which are used in the surface treatment may be similar to polymer compounds having a polymerizable double bond group which are suitably used in a photopolymerizable photosensitive layer described later. The description of details common to the following description will be appropriately omitted. The polymer compounds having a polymerizable double bond group which are used in the surface treatment are preferably polymer compounds that are formed of any repeating units and are such that side chains containing the polymerizable double bond group are bonded to the main chain via any linking groups. In particular, polymer compounds having a vinyl group as the reactive double bond group are preferably used, and polymer compounds in which a vinyl-substituted phenyl group is bonded to the main chain directly or via any linking group are particularly preferably used. In the surface treatment of the hydrophilic layer, such a polymer compound preferably participates in the surface treatment in the form of a solution in an aqueous medium, in which case the uniformity of the treatment may be advantageously enhanced. To realize this, the polymer compounds having a polymerizable double bond group are preferably those in which groups such as carboxyl groups, sulfonic groups and quaternary ammonium groups are bonded to the main chain via any linking groups, as will be illustrated later as polymer compounds suitably used in a photopolymerizable photosensitive layer. Specific preferred examples of the polymer compounds having a polymerizable double bond group include compounds represented by the formulae SP-1, SP-2, SP-3, CP-1, CP-2 and CP-3 described later.

The surface treatment in the invention refers to a process in which the polymer compound having a polymerizable double bond group is allowed to be present on the surface of the hydrophilic layer (including the surface of voids if any present in the hydrophilic layer) by a known coating technique such as dipping or fountain coating, by a combination of such a coating technique with a known remover such as air knife, or by spraying or blowing. That is, the surface treatment does not cause the polymer compound having a polymerizable double bond group to form a layer on the hydrophilic layer. In order to ensure that the polymer compound having a polymerizable double bond group will not form a layer, it is preferable to control the amount of the polymer compound present on the hydrophilic layer in the range of 10 to 200 mg/m².

In the invention, the surface treatment with the polymer compound having a polymerizable double bond group is preferably carried out in such a manner that the polymer compound having a polymerizable double bond group is dissolved or dispersed in an aqueous medium to give a surface treatment agent and the hydrophilic layer is treated with the surface treatment agent. This manner is preferable from the viewpoint of the uniformity of the treatment. In the surface treatment agent, the content of the polymer compound having a polymerizable double bond group is preferably not more than 10 mass %, and more preferably not more than 5 mass %. The lower limit is preferably 0.1 mass % or above, and more preferably 0.5 mass % or above.

The term aqueous medium in the surface treatment agent indicates that water represents at least 50 mass % or more, and preferably 80 mass % or more of the solvent components in the surface treatment agent. Examples of the solvents other than water include organic solvents highly miscible with water such as alcohols, glycols and glycerol.

The surface treatment agent may appropriately contain additives such as surfactants, pH adjustors and anti-foaming agents. Further, the surface treatment agent may contain other polymer compounds having no polymerizable double bond groups, for example, gelatins and polyvinyl alcohols, for such purposes as viscosity control. Such additional polymer compounds are preferably used in a content of not more than 50 mass %, more preferably not more than 20 mass %, and particularly preferably not more than 10 mass % relative to the polymer compounds having a polymerizable double bond group.

[symbol] Photopolymerizable Photosensitive Layers

[symbol]

Next, the negative photosensitive lithographic printing plates of the invention will be described. The negative photosensitive lithographic printing plate of the invention includes at least a photopolymerizable photosensitive layer on the hydrophilic layer of the lithographic printing plate support described above. Preferably, the photosensitive layer contains a photopolymerization initiator and a compound having a polymerizable double bond group.

The photopolymerization initiators may be any known such compounds. Examples include trihaloalkyl-substituted compounds (for example, trihaloalkyl-substituted nitrogen-containing heterocyclic compounds such as s-triazine compounds and oxadiazole derivatives, and trihaloalkylsulfonyl compounds), organic borate salts, hexaarylbiimidazoles, titanocene compounds, thio compounds and organic peroxides. Of these photopolymerization initiators, trihaloalkyl-substituted compounds and organic borate salts are particularly preferably used. It is more preferable to use combinations of trihaloalkyl-substituted compounds and organic borate salts. The combined use of trihaloalkyl-substituted compounds and organic borate salts realizes high sensitivity. Further, such a combined use results in the stabilization of the generated radical species and consequently further improves the sensitivity.

In detail, the trihaloalkyl-substituted compound photopolymerization initiators are compounds that have at least one or more trihaloalkyl groups such as trichloromethyl groups and tribromomethyl groups in the molecule. Preferred examples include s-triazine derivatives and oxadiazole derivatives in which the trihaloalkyl groups are bonded to nitrogen-containing heterocyclic groups, and trihaloalkylsulfonyl compounds in which the trihaloalkyl groups are bonded to aromatic rings or nitrogen-containing heterocyclic rings via sulfonyl groups.

The following illustrate particularly preferred examples of the compounds in which the trihaloalkyl groups are bonded to nitrogen-containing heterocyclic rings, and of the trihaloalkylsulfonyl compounds.

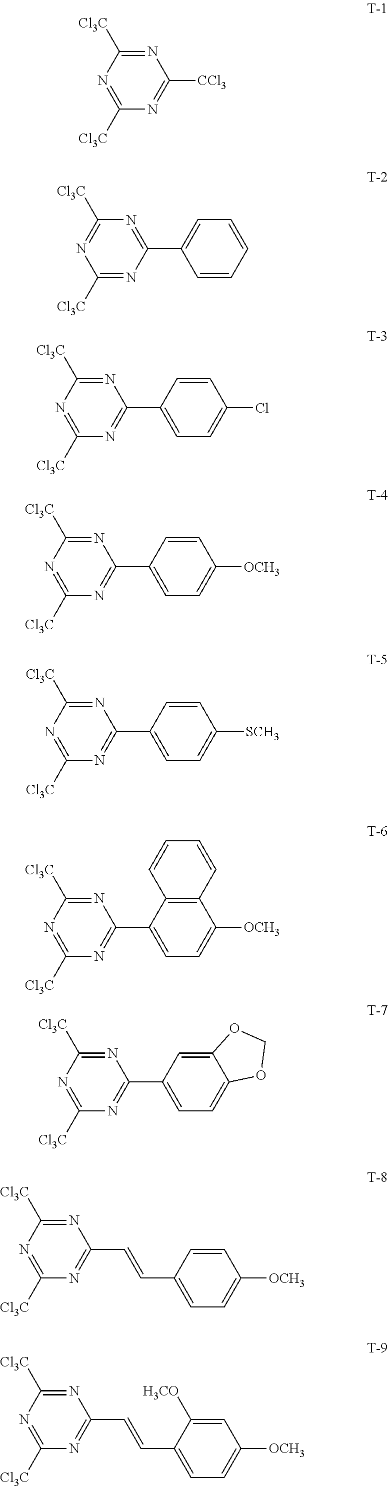

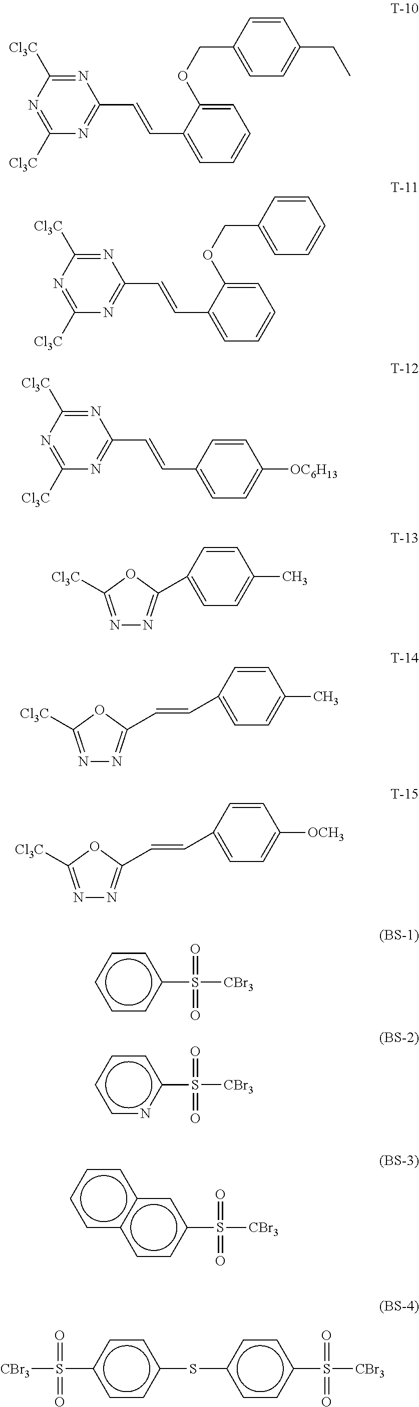

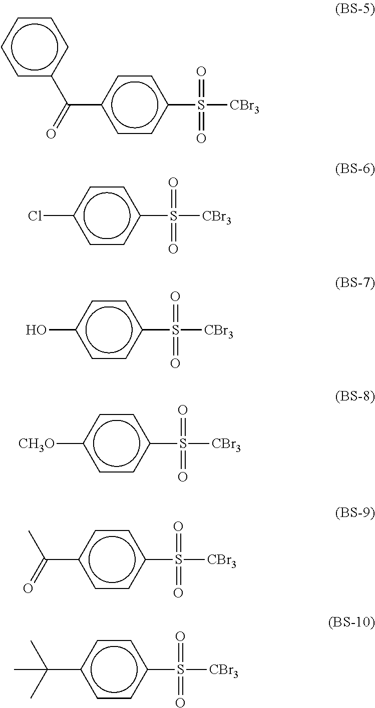

The organic borate anions that constitute the organic borate salts may be represented by General Formula 1 below.

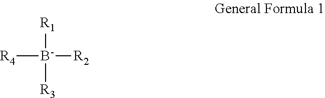

In the formula, R₁, R₂, R₃ and R₄, which may be the same or different from one another, indicate alkyl groups, aryl groups, aralkyl groups, alkenyl groups, alkynyl groups, cycloalkyl groups and heterocyclic groups. It is particularly preferable that any one of R₁, R₂, R₃ and R₄ be an alkyl group and the other substituents be aryl groups.

Examples of the cations that constitute the organic borate salts include alkali metal ions and onium compounds. Onium salts are preferable, with examples including ammonium salts such as tetraalkylammonium salts, sulfonium salts such as triarylsulfonium salts, and phosphonium salts such as triarylalkylphosphonium salts. The following illustrate particularly preferred examples of the organic borate salts.

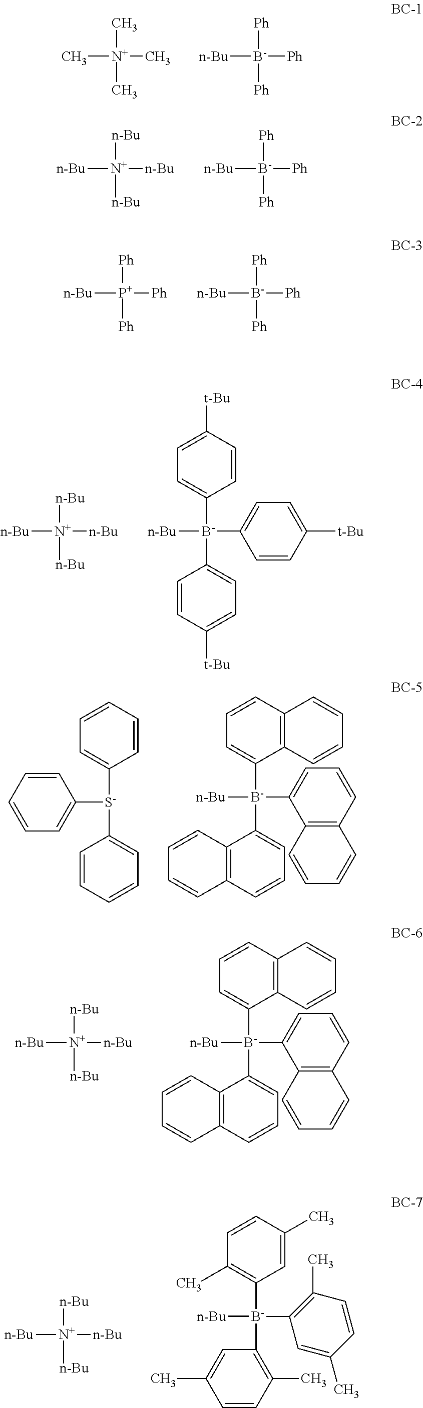

The content of the photopolymerization initiator is preferably in the range of 1 to 50 mass %, and more preferably in the range of 5 to 30 mass % relative to the compound having a polymerizable double bond group described below.

The compound having a polymerizable double bond group is a polymer compound having a polymerizable double bond group or a low-molecular weight compound having a polymerizable double bond group. In terms of photopolymerization efficiency, it is preferable to use a polymer compound having a polymerizable double bond group in combination with a low-molecular weight compound having a polymerizable double bond group.

The polymer compounds having a polymerizable double bond group will be described. The polymer compounds having a polymerizable double bond group are formed of any repeating units and are such that side chains containing the polymerizable double bond group are bonded to the main chain via any linking groups. In particular, polymer compounds having a vinyl group as the reactive double bond group are preferably used, and polymer compounds in which a vinyl-substituted phenyl group is bonded to the main chain directly or via any linking group are particularly preferably used. In order to realize developability with alkaline developers or neutral developers (chemical-less developers), it is preferable to introduce side chains including such groups as carboxyl groups, sulfonic groups and quaternary ammonium groups which are bonded to the main chain via any linking groups. In particular, polymer compounds having sulfonic groups in side chains may be preferably used from the viewpoint of high developability. The carboxyl groups and the sulfonic groups may form salts (for example, sodium salts, potassium salts, lithium salts and ammonium salts). The quaternary ammonium groups may form salts with any anions. The linking groups are not particularly limited, and examples thereof include any groups, atoms or combinations thereof. The vinyl-substituted phenyl groups and the sulfonic groups may be bonded to the main chain independently from each other, or the vinyl-substituted phenyl groups and the sulfonic groups may be bonded to the main chain by sharing portions or the entirety of the linking groups.

In the vinyl-substituted phenyl group, the phenyl group may be substituted. Further, the vinyl group may be substituted with substituents such as halogen atoms, carboxyl groups, sulfo groups, nitro groups, cyano groups, amide groups, amino groups, alkyl groups, aryl groups, alkoxy groups and aryloxy groups.

In the invention, specifically, the polymer compounds in which vinyl-substituted phenyl groups are bonded to the main chain directly or via any linking groups preferably have groups represented by General Formula 2 below in side chains.

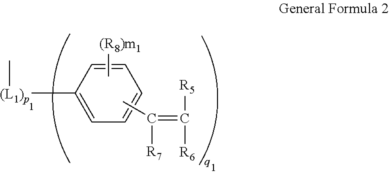

In the formula, R₅, R₆ and R₇, which may be the same or different from one another, indicate each independently a group selected from a hydrogen atom, a halogen atom, a carboxyl group, a sulfo group, a nitro group, a cyano group, an amide group, an amino group, an alkyl group, an aryl group, an alkoxy group, an aryloxy group, an alkylsulfanyl group, an arylsulfanyl group, an alkylamino group, an arylamino group, an acyl group, an alkoxycarbonyl group, an aryloxycarbonyl group, an alkylsulfonyl group and an arylsulfonyl group wherein the alkyl groups and the aryl groups in these groups may be substituted with substituents such as halogen atoms, carboxyl groups, sulfo groups, nitro groups, cyano groups, amide groups, amino groups, alkyl groups, aryl groups, alkenyl groups, hydroxy groups, alkoxy groups, aryloxy groups, alkylsulfanyl groups, arylsulfanyl groups, alkylamino groups, arylamino groups, acyl groups, alkoxycarbonyl groups, aryloxycarbonyl groups, alkylsulfonyl groups and arylsulfonyl groups. Of these groups, it is particularly preferable that R₅ and R₆ be hydrogen atoms and R₇ be a hydrogen atom or a lower alkyl group having 4 or less carbon atoms (for example, a methyl group or an ethyl group).

In the formula, R₈ indicates a group selected from a halogen atom, a carboxyl group, a nitro group, a cyano group, an amide group, an amino group, an alkyl group, an aryl group, an alkoxy group, an aryloxy group, an alkylsulfanyl group, an arylsulfanyl group, an alkylamino group, an arylamino group, an acyl group, an alkoxycarbonyl group, an aryloxycarbonyl group, an alkylsulfonyl group and an arylsulfonyl group. The alkyl groups and the aryl groups in these groups may be substituted with substituents such as halogen atoms, carboxyl groups, sulfo groups, nitro groups, cyano groups, amide groups, amino groups, alkyl groups, aryl groups, alkenyl groups, alkynyl groups, hydroxy groups, alkoxy groups, aryloxy groups, alkylsulfanyl groups, arylsulfanyl groups, alkylamino groups, arylamino groups, acyl groups, alkoxycarbonyl groups, aryloxycarbonyl groups, alkylsulfonyl groups and arylsulfonyl groups. When m₁ is a plural number, the plurality of R₈ may be the same or different from one another.

In the formula, L₁ indicates a polyvalent linking group formed of an atom selected from a carbon atom, a nitrogen atom, an oxygen atom and a sulfur atom, or formed of atoms selected from hydrogen atoms, carbon atoms, nitrogen atoms, oxygen atoms and sulfur atoms. Specific examples include groups composed of the structural units illustrated below, as well as include the heterocyclic groups illustrated below. These groups may be used singly, or any two or more groups may be combined.

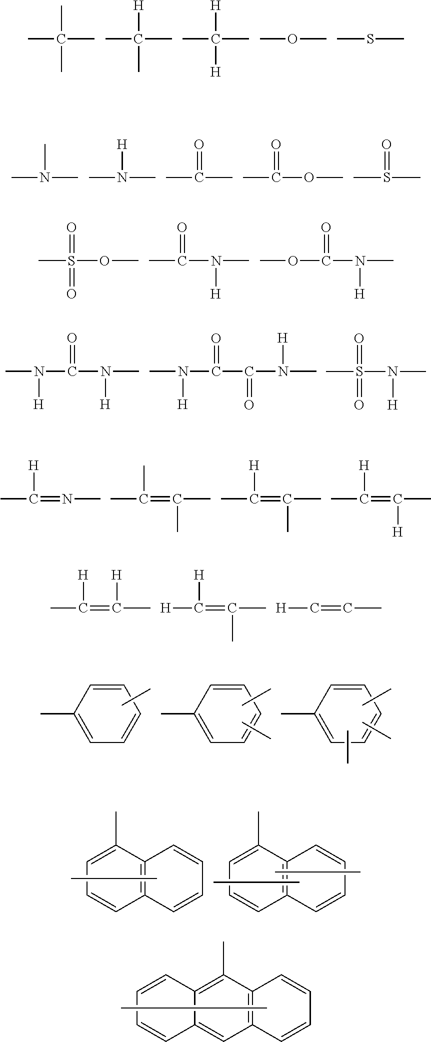

The linking group L₁ preferably includes a heterocyclic ring. Examples of the heterocyclic rings for constituting L₁ include nitrogen-containing heterocyclic rings such as pyrrole rings, pyrazole rings, imidazole rings, triazole rings, tetrazole rings, isoxazole rings, oxazole rings, oxadiazole rings, isothiazole rings, thiazole rings, thiadiazole rings, thiatriazole rings, indole rings, indazole rings, benzimidazole rings, benzotriazole rings, benzoxazole rings, benzothiazole rings, benzoselenazole rings, benzothiadiazole rings, pyridine rings, pyridazine rings, pyrimidine rings, pyrazine rings, triazine rings, quinoline rings and quinoxaline rings, furan rings and thiophene rings. These heterocyclic rings may have substituents.

Examples of the substituents which may be present on the polyvalent linking group include halogen atoms, carboxyl groups, sulfo groups, nitro groups, cyano groups, amide groups, amino groups, alkyl groups, aryl groups, alkenyl groups, alkynyl groups, hydroxy groups, alkoxy groups, aryloxy groups, alkylsulfanyl groups, arylsulfanyl groups, alkylamino groups, arylamino groups, acyl groups, alkoxycarbonyl groups, aryloxycarbonyl groups, alkylsulfonyl groups and arylsulfonyl groups.

In the formula, m₁ indicates an integer of 0 to 4, p₁ indicates an integer of 0 or 1, and q₁ indicates an integer of 1 to 4.

In the invention, the polymer compounds having a polymerizable double bond group may be polymers consisting solely of repeating units having the vinyl-substituted phenyl groups in side chains and repeating units having the sulfonic groups in side chains. As long as the advantageous effects of the invention are not impaired, other repeating units may be introduced into the polymers. Further, the polymers may be copolymers with other monomers. A single or any two or more kinds of monomers may be used.

In the invention, a chain transfer agent may be used to introduce any substituent to an end of the polymer main chain of the polymer compound having a polymerizable double bond group. In detail, a linear alkane thiol, in particular, a linear alkane thiol substituted with an alkoxylated or halogenated silicon atom may be preferably used as the chain transfer agent during polymerization, in which case the strength of the image portion may be advantageously increased. Examples of such chain transfer agents include 3-mercaptopropyl trimethoxysilane, 3-mercaptopropyl dimethoxymethylsilane, 3-mercaptopropyl triethoxysilane, 3-mercaptopropyl trichlorosilane, 3-mercaptopropyl dichloromethylsilane, 4-mercaptobutyl trimethoxysilane, 4-mercaptobutyl dimethoxymethylsilane, 4-mercaptobutyl triethoxysilane, 4-mercaptobutyl trichlorosilane and 4-mercaptobutyl dichloromethylsilane. These compounds may undergo hydrolysis condensation with the result that the silicon atoms at ends of the molecules are bonded to each other via an oxygen atom to form a siloxane bond.

The following illustrate preferred examples of the polymer compounds having a polymerizable double bond group in the invention. However, the scope of the invention is not limited to such examples. The numbers in the illustrated structural formulae indicate mass % of the respective repeating units in 100 mass % of the total composition of the copolymer.

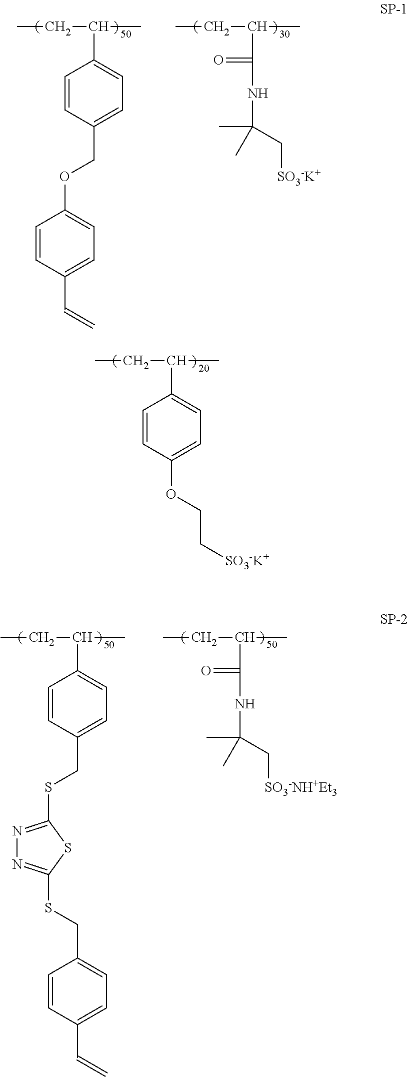

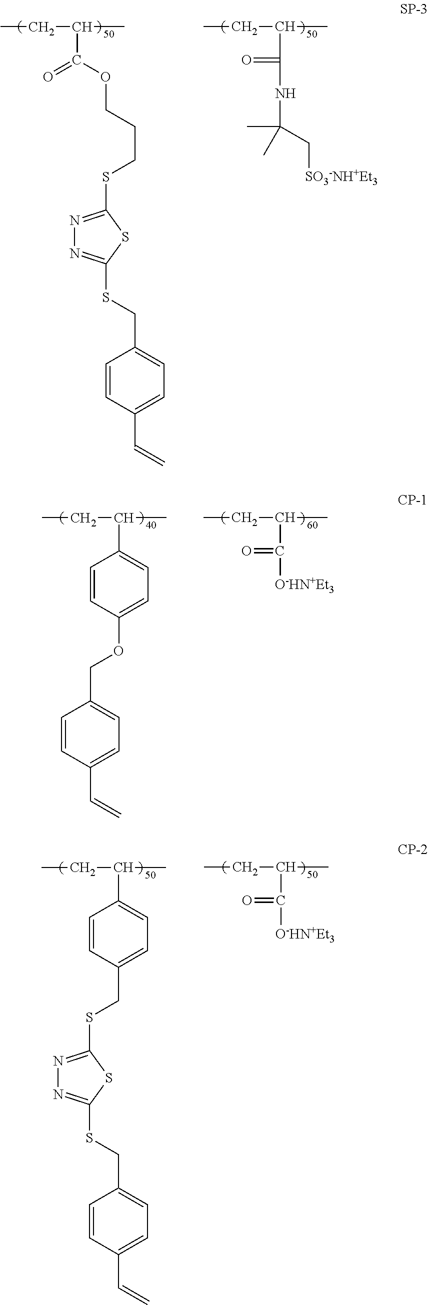

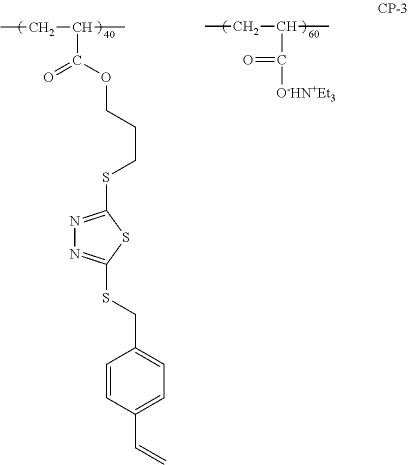

The polymer compounds having a polymerizable double bond group in the invention preferably have a weight average molecular weight in the range of 1,000 to 1,000,000, and more preferably in the range of 50,000 to 600,000. The polymer compounds having a polymerizable double bond group in the invention may be used singly, or any two or more kinds may be used as a mixture.

Next, there will be described the low-molecular weight compounds having a polymerizable double bond group which are used in the invention. In this case, any compounds that are polymerized by radicals generated by the photodecomposition of the photopolymerization initiator may be suitably used as the low-molecular weight compounds having a polymerizable double bond group. When the compounds that are used include a compound having two or more polymerizable double bond groups in the molecule, radical polymerization results in a crosslinked product and the obtainable negative photosensitive lithographic printing plate material forms a crosslinked and hard image area film. As a result, the printing plate advantageously exhibits excellent plate durability and ink coverage properties. Examples of the compounds having a polymerizable double bond group which may be used to this purpose include polyfunctional acrylic monomers such as 1,4-butanediol diacrylate, 1,6-hexanediol diacrylate, neopentyl glycol diacrylate, tetraethylene glycol diacrylate, trisacryloyloxyethyl isocyanurate, tripropylene glycol diacrylate, trimethylolpropane triacrylate, pentaerythritol triacrylate and pentaerythritol tetraacrylate. Further, various oligomers having an acryloyl group or a methacryloyl group such as polyester (meth)acrylate, urethane (meth)acrylate and epoxy (meth)acrylate may be similarly used.

The photosensitive layer in the inventive negative photosensitive lithographic printing plates preferably contains a sensitizer compound that sensitizes the aforementioned photopolymerization initiator. Examples of the sensitizer compounds include compounds that increase the sensitivity in the wavelength region from 400 to 430 nm such as cyanine dyes, coumarin compounds described in literature such as Japanese Patent Application Kokai Publications Nos. H7-271284 and H8-29973, carbazole compounds described in literature such as Japanese Patent Application Kokai Publications Nos. H9-230913 and 2001-42524, carbomerocyanine dyes described in literature such as Japanese Patent Application Kokai Publications Nos. H8-262715, H8-272096 and H9-328505, aminobenzylidene ketone dyes described in literature such as Japanese Patent Application Kokai Publications Nos. H4-194857, H6-295061, H7-84863, H8-220755, H9-80750 and H9-236913, pyrromethene dyes described in literature such as Japanese Patent Application Kokai Publications Nos. H4-184344, H6-301208, H7-225474, H7-5685, H7-281434 and H8-6245, styryl dyes described in literature such as Japanese Patent Application Kokai Publication No. H9-80751, and (thio)pyrylium compounds. Of these, cyanine dyes, or coumarin compounds or (thio)pyrylium compounds are preferable.

The photosensitive layer in the inventive negative photosensitive lithographic printing plates may contain other elements. For example, various colorants are preferably added to increase visibility. Aqueous dispersions of colored pigments may be most preferably used as the colorants for this purpose. Such aqueous dispersions of pigments may be any materials in which pigments colored in various colors including black, blue, red, green and yellow are dispersed in water in the presence of various water-soluble dispersants. In particular, such pigments as carbon black, phthalocyanine blue and phthalocyanine green may be particularly preferably used because they are easily available and are relatively easily dispersed in water. Examples of the dispersants which may be used to help these pigments be dispersed in water include oxyethylene group-containing and water-soluble nonionic surfactants such as polyethylene glycol and polypropylene glycol, and various water-soluble polymers such as polyacrylic acid, polyvinylpyrrolidone, polystyrene-maleic acid half ester copolymer and polystyrene-maleic acid copolymer. These dispersants are preferably present in an amount of 5 to 50 parts by mass with respect to 100 parts by mass of the colored pigments. When the colored pigments are used, the amount thereof is preferably in the range of 1 to 30 parts by mass with respect to 100 parts by mass of the compounds having a polymerizable double bond.

The photosensitive layer in the inventive negative photosensitive lithographic printing plates preferably contains a silane coupling agent. Plate durability is enhanced by adding silane coupling agents to photosensitive layers. In the negative photosensitive lithographic printing plates having the inventive hydrophilic layer, the use of silane coupling agents is particularly advantageous because the plate durability is enhanced without any deteriorations in scumming resistance, halftone staining resistance and ink releasability.

Any silane coupling agents may be used without limitation as long as the purpose is fulfilled. Examples include epoxycyclohexylethyltrimethoxysilane, glycidoxypropyltrimethoxysilane, acryloxypropyltrimethoxysilane, methacryloxypropyltrimethoxysilane, mercaptopropyltrimethoxysilane, mercaptopropyltriethoxysilane, methyltrimethoxysilane, dimethyldimethoxysilane, phenyltrimethoxysilane, diphenyldimethoxysilane, methyltriethoxysilane, dimethyldiethoxysilane, phenyltriethoxysilane, diphenyldiethoxysilane, styryltrimethoxysilane, styryltriethoxysilane, hexyltrimethoxysilane, decyltrimethoxysilane, vinyltris(3-methoxyethoxy)silane, vinyltriethoxysilane, vinyltrimethoxysilane, 3-methacryloyloxypropyltrimethoxysilane, 3-acryloyloxypropyltrimethoxysilane, 3-methacryloyloxypropyltriethoxysilane, β-(3,4-epoxycyclohexyl)ethyltrimethoxysilane, 3-glycidoxypropyltrimethoxysilane, 3-glycidoxypropylmethyldiethoxysilane, 3-methacryloyloxypropylmethyldiethoxysilane, N-β(aminoethyl)-γ-aminopropyltrimethoxysilane, N-β(aminoethyl)-aminopropylmethyldimethoxysilane, 3-aminopropyltriethoxysilane, N-phenyl-γ-aminopropyltrimethoxysilane, 3-mercaptopropyltrimethoxysilane, 3-chloropropyltrimethoxysilane and 3-isocyanatopropyltriethoxysilane. Of these, trialkoxysilanes such as epoxycyclohexylethyltrimethoxysilane, glycidoxypropyltrimethoxysilane, vinyltrimethoxysilane, vinyltriethoxysilane, acryloxypropyltrimethoxysilane, methacryloxypropyltrimethoxysilane, mercaptopropyltrimethoxysilane, mercaptopropyltriethoxysilane and 3-acryloyloxypropyltrimethoxysilane are particularly preferable. The silane coupling agents may be used singly, or two or more kinds may be used in any combination and in any proportions.

In the photosensitive layer, the content of the silane coupling agent is preferably in the range of 0.2 to 20 mass %, and more preferably in the range of 0.5 to 10 mass % relative to the compounds having a polymerizable double bond group that are present in the photosensitive layer.

Another element in the photosensitive layer relates to long-term storage. That is, a polymerization inhibitor is preferably added to prevent the occurrence of curing reaction by thermal polymerization in a dark place. Examples of the polymerization inhibitors suitably used to this purpose include various compounds with a phenolic hydroxyl group such as hydroquinones, catechols, naphthols and cresols, as well as quinone compounds, 2,2,6,6-tetramethylpiperidine-N-oxyl compounds and N-nitrosophenylhydroxylamine salts. In this case, the amount of the polymerization inhibitors is preferably in the range of 0.01 to 10 parts by mass with respect to 100 parts by mass of the total solid mass content in the inventive photosensitive composition.

The amount of application of the photosensitive layer itself is preferably in the range of 0.3 to 10 g in terms of dry solid mass per 1 m², and is highly preferably in the range of 0.5 to 3 g to make sure that good resolution is obtained, that plate durability in the printing of fine line images and minute dot images is ensured, and that ink coverage properties are markedly improved.

[symbol] Protective Layers

[symbol]

In the negative photosensitive lithographic printing plate material of the invention, it is also preferable to provide a protective layer on the photosensitive layer. The protective layer advantageously serves to prevent the entry into the photosensitive layer of low-molecular weight compounds such as atmospheric oxygen and basic substances that inhibit the photo-induced image-forming reaction in the photosensitive layer and thereby to further enhance the photosensitivity in the air. In addition, the protective layer is expected to exhibit an effect of preventing the photosensitive layer surface from scratches. Thus, the protective layer desirably has such characteristics that the layer exhibits low permeability to low-molecular weight compounds such as oxygen, shows excellent mechanical strength, does not substantially inhibit the penetration of light used for photoexposure, has excellent adhesion with the photocurable photosensitive layer, and can be easily removed by the development step after the photoexposure.

Protective layers designed to achieve such characteristics are described in detail in literature such as U.S. Pat. No. 3,458,311 and Japanese Patent Application Kokai Publication No. S55-49729. For example, water-soluble polymer compounds having relatively excellent crystallinity are suitably used as the protective layer materials. In detail, known such water-soluble polymers include polyvinyl alcohol, polyvinylpyrrolidone, acidic celluloses, gelatin, gum arabic and polyacrylic acid. Of these, the use of polyvinyl alcohol as the main component gives the best results in terms of basic characteristics such as oxygen impermeability and develop ability. The polyvinyl alcohol used in the protective layer may be partially substituted with esters, ethers and acetals as long as the polymer contains unsubstituted vinyl alcohol units providing the required oxygen impermeability and water solubility. Similarly, the polymer may have comonomer components at portions. In the formation of the protective layer, the amount of application in terms of dry solid mass is preferably in the range of 0.1 to 10 g, and more preferably in the range of 0.2 to 2 g per 1 m² in terms of dry mass on the photosensitive layer. The protective layer may be formed on the photosensitive layer by any of various known application processes followed by drying.

The hydrophilic layer in the inventive lithographic printing plate support, and the upper layers disposed thereon such as the photopolymerizable photosensitive layer and the protective layer may be formed by application processes. In such cases, these layers are fabricated by applying and drying the coating liquids of compositions including the aforementioned components onto the substrate or the support. The application methods may be any of various known methods, with examples including bar coating, slide hopper coating, curtain coating, blade coating, air knife coating, roll coating, rotational coating and dip coating.

[symbol] Development Treatments

[symbol]

The developers in the development treatment may contain surfactants or alkaline agents as required for purposes such as improving the image quality and shortening the development time. In the case where the aforementioned compounds having a polymerizable double bond have acidic groups such as carboxyl groups or sulfonic groups and the acidic groups are in the form of metal salts or amine salts in the photosensitive layer, the development is feasible with developers that are substantially free from alkaline agents described later, namely, neutral developers having a pH of less than 9. In particular, good developability may be obtained and the development is possible with pure water when the compounds having a polymerizable double bond have a neutralized sulfonate salt group. In the case of neutralized carboxylate salt groups or if sufficient solubility is not obtained even with neutralized sulfonate salt groups, activators such as surfactants and water-soluble organic solvents may be added to the neutral developers to increase the developability.

Examples of the surfactants include nonionic surfactants such as polyoxyethylene alkyl ethers, polyoxyethylene alkylaryl ethers, polyoxyethylene alkyl esters, sorbitan alkyl esters and monoglyceride alkyl esters; anionic surfactants such as alkylbenzene sulfonate salts, alkylnaphthalene sulfonate salts, alkyl sulfate salts, alkyl sulfonate salts and sulfosuccinate ester salts; and amphoteric surfactants such as alkyl betaines and amino acids. Examples of the water-soluble organic solvents include isopropyl alcohol, benzyl alcohol, ethyl cellosolve, butyl cellosolve, phenyl cellosolve, propylene glycol and diacetone alcohol.

When the compounds having a polymerizable double bond have unneutralized acidic groups such as carboxyl groups or sulfa groups, the developers preferably contain alkaline agents. Examples of the alkaline agents include inorganic alkali salts such as sodium silicate, potassium silicate, lithium silicate, ammonium silicate, sodium metasilicate, potassium metasilicate, sodium hydroxide, potassium hydroxide, lithium hydroxide, sodium carbonate, sodium bicarbonate, potassium carbonate, dibasic sodium phosphate, tribasic sodium phosphate, dibasic ammonium phosphate, tribasic ammonium phosphate, sodium borate, potassium borate and ammonium borate; monomethylamine, dimethylamine, trimethylamine, mono ethylamine, diethylamine, triethylamine, monoisopropylamine, diisopropylamine, monobutylamine, monoethanolamine, diethanolamine, triethanolamine, monoisopropanolamine and diisopropanolamine. The developers may be adjusted to an alkaline pH of not less than 9 by the addition of these agents. To improve developability, it is also preferable to add components used in the neutral developers such as the activators to the alkaline developers.

The development is carried out by any known development methods such as immersion development, spray development, brush development and ultrasonic development, preferably at a temperature of about 10 to 60° C., more preferably about 15 to 45° C. for about 5 seconds to 10 minutes. In this process, the protective layer optionally disposed on the photosensitive layer may be removed beforehand with water or the like or may be removed during the development.

### EXAMPLES

Hereinbelow, the present invention will be described by presenting Examples without limiting the scope of the invention to such description. In the following description, the units “%” and “part(s)” are on the mass basis unless otherwise mentioned.

### Example 1

[symbol] Hydrophilic Layer and Lithographic Printing Plate Support

[symbol]

A hydrophilic layer-coating liquid 1 having the following composition was applied onto an approximately 200 μm thick polyethylene terephthalate film by a slide hopper coating method. During this process, the amount of wet coating had been previously set to 35 g/m². Immediately after the application, the coating was gelled by the application of cold air at 1 to 5° C. and was thereafter dried with dry wind controlled at 50° C. After the drying, the film was heat treated for 7 days in a thermo-hygrostat chamber controlled at 40° C. and 40% RH. Thus, a lithographic printing plate support was completed.

[symbol] Hydrophilic Layer-Coating Liquid 1

[symbol]

| | |
|---|---|
| Gelatin: GEL type I | 1.2 parts |
| (Alkali-treated gelatin from beef bone ossein: | |
| a mixture of first and second gelatin extracts) | |
| Inorganic filler 1: titanium dioxide | 4.0 parts |
| (TISR 1 manufactured by SAKAI CHEMICAL | |
| INDUSTRY CO., LTD., average primary | |
| particle diameter ≈ 0.3 μm, relative | |
| refractive index ≈ 2.04) | |
| Inorganic filler 2: barium sulfate | 1.6 parts |
| (B35 manufactured by SAKAI CHEMICAL | |
| INDUSTRY CO., LTD., average primary | |
| particle diameter ≈ 0.3 μm, relative | |
| refractive index ≈ 1.23) | |
| Inorganic filler 3: aluminum hydroxide | 0.4 parts |
| (H42 manufactured by SHOWA DENKO K.K., average | |
| primary particle diameter ≈ 1.0 μm, relative | |
| refractive index ≈ 1.24) | |
| Dispersant (acrylic acid copolymer metal salt, 10% solution) | 1.0 part |
| Surfactant | 0.4 parts |
| (sodium polyoxyethylene nonylphenyl | |
| ether sulfate, 10% solution) | |
| Crosslinking agent (divinyl sulfone, 5% solution) | 4.0 parts |

The total amount was adjusted to 35 parts with water.

With respect to GEL type I (alkali-treated gelatin from beef bone ossein, a mixture of first and second gelatin extracts) used in the hydrophilic layer-coating liquid 1, the eluting protein content and the jelly strength were determined by the measurement methods specified in “PAGI METHOD, METHODS FOR TESTING PHOTOGRAPHIC GELATIN, Tenth Edition, November 2006, COMMISSION ON METHODS FOR TESTING PHOTOGRAPHIC GELATIN”. As a result, the eluting protein content was 1.9% and the jelly strength was 249 g.

The particle size distributions and the distribution frequencies were measured for the inorganic fillers present in the hydrophilic layer-coating liquid 1. Specifically, a hydrophilic layer-coating liquid containing the inorganic filler 1 was prepared without the addition of the inorganic fillers 2 and 3 used in the hydrophilic layer-coating liquid 1. In a similar manner, respective hydrophilic layer-coating liquids of the inorganic fillers 2 and 3 were prepared. The particle size distribution and the distribution frequencies of each inorganic filler were measured with a laser diffraction/scattering particle size distribution analyzer (LA920 manufactured by HORIBA, Ltd.), and the particle size distributions of the respective filler dispersions were multiplied by coefficients which were the ratios of the fillers added, thereby calculating the particle size distribution and the distribution frequencies of the hydrophilic layer-coating liquid 1. The results are described in Table 1.

[symbol] Photopolymerizable Photosensitive Layer

[symbol]

The following photopolymerizable photosensitive layer-coating liquid was applied onto the hydrophilic layer such that the solid mass would be 1.5 g/m² and was dried in a dryer at 75° C. for 10 minutes.

[symbol] Photopolymerizable Photosensitive Layer-Coating Liquid

[symbol]

| | | |
|---|---|---|
| Sulfonic acid polymer SP-2 (weight average molecular weight | 1 | part |
| 400,000) | | |
| Pentaerythritol tetraacrylate | 0.5 | parts |
| 3-Acryloyloxypropyl trimethoxysilane | 0.08 | parts |
| Photopolymerization initiator BC-6 | 0.1 | part |
| Photopolymerization initiator T-8 | 0.1 | part |
| Sensitizer illustrated below | 0.05 | parts |
| Colorant Pigment Blue 15 | 0.2 | parts |
| Acetone | 5 | parts |
| Ethanol | 5 | parts |
| Tetrahydrofuran | 10 | parts |

Sensitizer

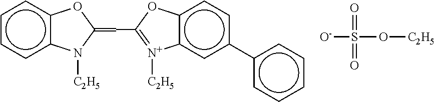

[symbol] Protective Layer

[symbol]

A coating liquid was prepared according to the following protective layer formulation, and was applied onto the photopolymerizable photosensitive layer such that the solid mass would be 1.5 g/m². After the application, the coating was dried in a dryer at 75° C. for 10 minutes. Thus, a negative photosensitive lithographic printing plate was obtained.

[symbol] Protective Layer Formulation

[symbol]

| | |
|---|---|
| Polyvinyl alcohol PVA-102 (manufactured | 1 part |
| by KURARAY CO., LTD.) | |
| Ion exchange water | 9 parts |

[symbol] Photoexposure and Development Treatment

[symbol]

The negative photosensitive lithographic printing plate obtained above was photoexposed with use of a blue-violet semiconductor laser emitting 405 nm light (output 50 mW) as a photoexposure light source while the photoexposure energy on the plate surface was set at 200 μJ/cm², thereby drawing a test chart image. Thereafter, the plate was immersed in ion exchange water at 25° C. for 15 seconds and the surface of the side having the photopolymerizable photosensitive layer/the protective layer was rubbed with a cellulose sponge to develop the image. The plate was then dried. Thus, a printing plate was fabricated. The printing plate was tested by the following methods to evaluate plate durability, scumming resistance, ink releasability and halftone staining resistance. In each evaluation, the symbol x indicates that the printing plate is unusable in practical applications.

[symbol] Plate Durability

[symbol]

Printing was performed with use of offset sheet-fed printer Heidelberg QM46 as the printer, New Champion F-Gloss Black H manufactured by DIC Corporation as the printing ink, and a 1% dilute solution of ASTRO MARK III manufactured by NIKKEN CHEMICAL LABORATORY CO., LTD. as the fountain solution. The cylinder gap was changed from standard 200 μm to 300 μm (+100 μm) with a gauge film. The evaluation was made by comparing to each other the surface of the first printed sheet and the surface of the 10,000th printed sheet. Specifically, the printed sheets were carefully inspected with a 25× loupe for attenuation in 5-20% highlight halftone dot sections as well as abnormalities such as minute defects on solid sections. The plate durability was evaluated based on the following criteria. The results are described in Table 1.

⊚: Substantially no changes were found in the highlight sections and the solid sections.

◯: Slight attenuation (attenuation rate: within 10%) was observed in the highlight sections, but no defects were found in the solid sections.

Δ: Clear attenuation (attenuation rate: 10% or more) was observed in the highlight sections, but no defects were found in the solid sections.

x: Half or more of the highlight sections had been attenuated, or abnormalities such as defects were found in the solid sections.

[symbol] Scumming Resistance

[symbol]

Printing was performed with use of offset sheet-fed printer Heidelberg QM46 as the printer similarly to the plate durability evaluation, New Champion F-Gloss Purple S as the printing ink, and a 1% dilute solution of CombiFIX-XL manufactured by Huber Group as the fountain solution. The cylinder gap was standard 200 μm. To evaluate the scumming resistance, up to 3,000 sheets were printed and the surface of the first printed sheet was compared to the surface of any of the subsequent printed sheets. The scumming resistance was evaluated based on the following criteria. The results are described in Table 1.

⊚: Scumming did not occur during 3,000 impressions.

◯: Scumming occurred during between 2,000 and less than 3,000 impressions.

Δ: Scumming occurred during between 1,000 and less than 2,000 impressions.

x: Scumming occurred during between 1 and less than 1,000 impressions.

[symbol] Ink Releasability

[symbol]

Printing was performed with use of offset sheet-fed printer Heidelberg QM46 as the printer similarly to the plate durability evaluation, HY UNITY NEO SOY Pink LZ manufactured by TOYO INK SC HOLDINGS CO., LTD. as the printing ink, and a 1% dilute solution of ASTRO MARK III manufactured by NIKKEN CHEMICAL LABORATORY CO., LTD. as the fountain solution. The cylinder gap was standard 200 μm. The printing method was such that an ink foam roller was allowed to touch the dry printing face and to rotate two times before a water foam roller was allowed to touch the printing plate, and immediately thereafter paper feed was initiated and simultaneously the water foam roller was allowed to touch the print face. The number of sheets required until the surface of the printed sheet became completely free from contamination was determined. The ink releasability was evaluated based on the following criteria. The results are described in Table 1.

⊚: The non-image areas became completely free from contamination after one to less than twenty sheets were fed.

◯: The non-image areas became completely free from contamination after twenty to less than fifty sheets were fed.

Δ: The non-image areas became completely free from contamination after fifty to less than one hundred sheets were fed.

x: One hundred or more sheets were required until the non-image areas became completely free from contamination.

[symbol] Halftone Staining Resistance

[symbol]

Filling in of halftones refers to a phenomenon in which blanket piling results from repeated impressions and the ink comes to be deposited even onto non-image areas around the periphery of image areas to cause tinting (staining) in shadows in the halftone dot images depending on the printing conditions. After the printer was operated to perform at least 500 impressions for the above evaluation of ink releasability, the printer was temporarily stopped to wash only the blanket. Thereafter, the water foam roller was allowed to touch the printing face and to rotate five or more times as normal and thereafter paper feed was initiated to perform printing. To evaluate the halftone staining resistance, the surface of the 5,000th printed sheet was inspected and was evaluated based on the following criteria. The results are described in Table 1.

⊚: Stains were not observed even in at least 90% shadows, and reproducibility had no problems.

◯: Slight stains were observed in 85% to less than 90% halftone dot sections, but no practical problems would be caused.

Δ: Stains were observed in 70% to less than 85% halftone dot sections.

x: Stains were observed in less than 70% halftone dot sections, and reproducibility had problems.

### Example 2

A negative photosensitive lithographic printing plate was obtained in the same manner as in Example 1, except that the hydrophilic layer-coating liquid 1 used in Example 1 was changed to the following hydrophilic layer-coating liquid 2. The particle size distribution and the distribution frequencies of the inorganic fillers in the hydrophilic layer-coating liquid 2 were measured by the same methods as in Example 1. Further, the printing suitability of the obtained negative photosensitive lithographic printing plate was evaluated in the same manner as in Example 1. The results are described in Table 1.

[symbol] Hydrophilic Layer-Coating Liquid 2

[symbol]

| | |
|---|---|
| Gelatin: GEL type I | 1.2 parts |
| (Alkali-treated gelatin from beef bone ossein: a | |
| mixture of first and second gelatin extracts) | |
| Inorganic filler 1: titanium dioxide | 4.0 parts |
| (TISR 1 manufactured by SAKAI CHEMICAL | |
| INDUSTRY CO., LTD., average primary particle | |
| diameter ≈ 0.3 μm, relative refractive index ≈ 2.04) | |
| Inorganic filler 2: barium sulfate | 1.0 part |
| (B35 manufactured by SAKAI CHEMICAL | |
| INDUSTRY CO., LTD., average primary particle | |
| diameter ≈ 0.3 μm, relative refractive index ≈ 1.23) | |
| Inorganic filler 3: aluminum hydroxide | 1.0 part |
| (H42 manufactured by SHOWA DENKO K.K., average primary | |
| particle diameter ≈ 1.0 μm, relative refractive index ≈ 1.24) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Example 3

A negative photosensitive lithographic printing plate was obtained in the same manner as in Example 1, except that the hydrophilic layer-coating liquid 1 used in Example 1 was changed to the following hydrophilic layer-coating liquid 3. The particle size distribution and the distribution frequencies of the inorganic fillers in the hydrophilic layer-coating liquid 3 were measured by the same methods as in Example 1. Further, the printing suitability of the obtained negative photosensitive lithographic printing plate was evaluated in the same manner as in Example 1. The results are described in Table 1.

[symbol] Hydrophilic Layer-Coating Liquid 3

[symbol]

| | |
|---|---|
| Gelatin: GEL type I | 1.2 parts |
| (Alkali-treated gelatin from beef bone ossein: a mixture | |
| of first and second gelatin extracts) | |
| Inorganic filler 1: titanium dioxide | 4.0 parts |
| (TISR 1 manufactured by SAKAI CHEMICAL | |
| INDUSTRY CO., LTD., average primary particle | |
| diameter ≈ 0.3 μm, relative refractive index ≈ 2.04) | |
| Inorganic filler 2: barium sulfate | 0.4 parts |
| (B35 manufactured by SAKAI CHEMICAL | |
| INDUSTRY CO., LTD., average primary particle | |
| diameter ≈ 0.3 μm, relative refractive index ≈ 1.23) | |
| Inorganic filler 3: aluminum hydroxide | 1.6 parts |
| (H42 manufactured by SHOWA DENKO K.K., average primary | |
| particle diameter ≈ 1.0 μm, relative refractive index ≈ 1.24) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Example 4

A negative photosensitive lithographic printing plate was obtained in the same manner as in Example 1, except that the hydrophilic layer-coating liquid 1 used in Example 1 was changed to the following hydrophilic layer-coating liquid 4. Because a single inorganic filler was used, the particle size distribution and the distribution frequencies of the inorganic filler were measured directly with respect to the hydrophilic layer-coating liquid 4. Further, the printing suitability of the obtained negative photosensitive lithographic printing plate was evaluated in the same manner as in Example 1. The results are described in Table 1.

[symbol] Hydrophilic Layer-Coating Liquid 4

[symbol]

| | |
|---|---|
| Gelatin: GEL type I | 1.2 parts |
| (Alkali-treated gelatin from beef bone ossein: a mixture of first and second gelatin | |
| extracts) | |
| Inorganic filler 1: titanium dioxide | 6.0 parts |
| (TISR 1 manufactured by SAKAI CHEMICAL INDUSTRY CO., LTD., average | |
| primary particle diameter ≈ 0.3 μm, relative refractive index ≈ 2.04) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Example 5

A negative photosensitive lithographic printing plate was obtained in the same manner as in Example 1, except that the hydrophilic layer-coating liquid 1 used in Example 1 was changed to the following hydrophilic layer-coating liquid 5. Because a single inorganic filler was used, the particle size distribution and the distribution frequencies of the inorganic filler were measured directly with respect to the hydrophilic layer-coating liquid 5. Further, the printing suitability of the obtained negative photosensitive lithographic printing plate was evaluated in the same manner as in Example 1. The results are described in Table 1.

[symbol] Hydrophilic layer-coating liquid 5

[symbol]

| | |
|---|---|
| Gelatin: GEL type I | 1.2 parts |
| (Alkali-treated gelatin from beef bone ossein: a mixture of first and second gelatin | |
| extracts) | |
| Inorganic filler 1: barium sulfate | 6.0 parts |
| (B35 manufactured by SAKAI CHEMICAL INDUSTRY CO., LTD., average primary | |
| particle diameter ≈ 0.3 μm, relative refractive index ≈ 1.23) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Example 6

A negative photosensitive lithographic printing plate was obtained in the same manner as in Example 1, except that the hydrophilic layer-coating liquid 1 used in Example 1 was changed to the following hydrophilic layer-coating liquid 6. The particle size distribution and the distribution frequencies of the inorganic fillers in the hydrophilic layer-coating liquid 6 were measured by the same methods as in Example 1. Further, the printing suitability of the obtained negative photosensitive lithographic printing plate was evaluated in the same manner as in Example 1. The results are described in Table 1.

[symbol] Hydrophilic Layer-Coating Liquid 6

[symbol]

| | |
|---|---|
| Gelatin: GEL type I | 1.2 parts |
| (Alkali-treated gelatin from beef bone ossein: a mixture of first and second gelatin | |
| extracts) | |
| Inorganic filler 1: titanium dioxide | 4.0 parts |
| (TISR 1 manufactured by SAKAI CHEMICAL INDUSTRY CO., LTD., average | |
| primary particle diameter ≈ 0.3 μm, relative refractive index ≈ 2.04) | |
| Inorganic filler 2: barium sulfate | 2.0 parts |
| (B35 manufactured by SAKAI CHEMICAL INDUSTRY CO., LTD., average primary | |
| particle diameter ≈ 0.3 μm, relative refractive index ≈ 1.23) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Example 7

A negative photosensitive lithographic printing plate was obtained in the same manner as in Example 1, except that the hydrophilic layer-coating liquid 1 used in Example 1 was changed to the following hydrophilic layer-coating liquid 7. The particle size distribution and the distribution frequencies of the inorganic fillers in the hydrophilic layer-coating liquid 7 were measured by the same methods as in Example 1. Further, the printing suitability of the obtained negative photosensitive lithographic printing plate was evaluated in the same manner as in Example 1. The results are described in Table 1.

[symbol] Hydrophilic Layer-Coating Liquid 7

[symbol]

| | |
|---|---|
| Gelatin: GEL type I | 1.2 parts |
| (Alkali-treated gelatin from beef bone ossein: a mixture of first and second gelatin | |
| extracts) | |
| Inorganic filler 1: titanium dioxide | 2.0 parts |
| (TISR 1 manufactured by SAKAI CHEMICAL INDUSTRY CO., LTD., average | |
| primary particle diameter ≈ 0.3 μm, relative refractive index ≈ 2.04) | |
| Inorganic filler 2: barium sulfate | 4.0 parts |
| (B35 manufactured by SAKAI CHEMICAL INDUSTRY CO., LTD., average primary | |
| particle diameter ≈ 0.3 μm, relative refractive index ≈ 1.23) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Comparative Example 1

A negative photosensitive lithographic printing plate was obtained in the same manner as in Example 1, except that the hydrophilic layer-coating liquid 1 used in Example 1 was changed to the following hydrophilic layer-coating liquid 8. The particle size distribution and the distribution frequencies of the inorganic fillers in the hydrophilic layer-coating liquid 8 were measured by the same methods as in Example 1. Further, the printing suitability of the obtained negative photosensitive lithographic printing plate was evaluated in the same manner as in Example 1. The results are described in Table 1.

[symbol] Hydrophilic Layer-Coating Liquid 8

[symbol]

| | |
|---|---|
| Gelatin: GEL type I | 1.2 parts |
| (Alkali-treated gelatin from beef bone ossein: a mixture of first and second gelatin | |
| extracts) | |
| Inorganic filler 1: porous silica | 2.0 parts |
| (SYLOJET P403 manufactured by GRACE Davison, average primary particle | |
| diameter ≈ 3 μm, relative refractive index ≈ 1.09) | |
| Inorganic filler 2: colloidal silica | 0.2 parts |
| (SNOWTEX OXS manufactured by NISSAN CHEMICAL INDUSTRIES, LTD., | |
| average particle diameter ≈ 5 nm, relative refractive index ≈ 1.85) | |
| Inorganic filler 3: colloidal silica | 4.0 parts |
| (SNOWTEX OL manufactured by NISSAN CHEMICAL INDUSTRIES, LTD., | |
| average particle diameter ≈ 45 nm, relative refractive index ≈ 1.85) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

### Comparative Example 2

A negative photosensitive lithographic printing plate was obtained in the same manner as in Example 1, except that the hydrophilic layer-coating liquid 1 used in Example 1 was changed to the following hydrophilic layer-coating liquid 9. The particle size distribution and the distribution frequencies of the inorganic fillers in the hydrophilic layer-coating liquid 9 were measured by the same methods as in Example 1. Further, the printing suitability of the obtained negative photosensitive lithographic printing plate was evaluated in the same manner as in Example 1. The results are described in Table 1.

[symbol] Hydrophilic layer-coating liquid 9

[symbol]

| | |
|---|---|
| Gelatin: GEL type I | 1.2 parts |
| (Alkali-treated gelatin from beef bone ossein: a mixture of first and second gelatin | |
| extracts) | |
| Inorganic filler 1: porous silica | 4.2 parts |
| (SYLYSIA 435 manufactured by FUJI SILYSIA CHEMICAL LTD., average primary | |
| particle diameter ≈ 4.1 μm, relative refractive index ≈ 1.09) | |
| Inorganic filler 2: colloidal silica | 1.8 parts |
| (SNOWTEX S manufactured by NISSAN CHEMICAL INDUSTRIES, LTD., average | |
| particle diameter ≈ 9.5 nm, relative refractive index ≈ 1.85) | |
| Dispersant (acrylic acid copolymer metal salt, 10% solution) | 1.0 part |
| Surfactant | 0.4 parts |
| (sodium polyoxyethylene nonylphenyl ether sulfate, 10% solution) | |
| Crosslinking agent (divinyl sulfone, 5% solution) | 4.0 parts |

The total amount was adjusted to 35 parts with water.

TABLE 1

| | | | | Printing suitability | | | |
|---|---|---|---|---|---|---|---|
| | | | | | | | Halftone |
| | Distribution frequencies | | | Plate | Scumming | Ink | staining |
| | fx [%] | fy [%] | fx/fy | durability | resistance | releasability | resistance |
| Ex. 1 | 64.8 | 30.1 | 2.15 | ⊚ | ⊚ | ⊚ | ⊚ |
| Ex. 2 | 57.0 | 34.1 | 1.67 | ⊚ | ◯ | ◯ | ◯ |
| Ex. 3 | 49.1 | 38.1 | 1.29 | ⊚ | Δ | Δ | Δ |
| Ex. 4 | 65.4 | 33.1 | 1.98 | ◯ | ◯ | ◯ | ◯ |
| Ex. 5 | 79.1 | 15.9 | 4.97 | Δ | ⊚ | ⊚ | ◯ |
| Ex. 6 | 70.0 | 27.4 | 2.55 | ◯ | ⊚ | ⊚ | ◯ |
| Ex. 7 | 74.6 | 21.6 | 3.45 | Δ | ◯ | ⊚ | ◯ |
| Comp. | 0 | 0 | — | ⊚ | X | X | X |
| Ex. 1 | | | | | | | |
| Comp. | 0 | 0 | — | ⊚ | X | X | X |
| Ex. 2 | | | | | | | |

From Table 1, it has been demonstrated that the lithographic printing plate supports and the negative photosensitive lithographic printing plates according to the invention achieved excellent properties in all of plate durability, scumming resistance, ink releasability and halftone staining resistance.

### Example 8

The negative photosensitive lithographic printing plate in Example 1 was subjected to the following photoexposure and low-temperature development treatment as well as to the evaluation described below. The results are described in Table 2.

[symbol] Photoexposure and Low-Temperature Development Treatment

[symbol]

The negative photosensitive lithographic printing plate was photoexposed with use of a blue-violet semiconductor laser emitting 405 nm light (output 50 mW) as a photoexposure light source while the photoexposure energy on the plate surface was set at 200 μJ/cm², thereby drawing a test chart image. Thereafter, the plate was immersed in ion exchange water at 18° C. for 15 seconds and the surface of the side having the photopolymerizable photosensitive layer/the protective layer was rubbed with a cellulose sponge. The plate was then dried. Thus, a printing plate was fabricated. The printing plate was tested by the following method to evaluate wash-off properties. Further, the printing suitability was evaluated with respect to plate durability and scumming resistance in the same manner as in Example 1.

[symbol] Wash-Off Properties

[symbol]

With respect to the printing plate obtained by the photoexposure and development treatment, the contact angle in a non-image area was measured. Wash-off properties were evaluated based on the difference from the contact angle of the hydrophilic layer that had been measured before the photopolymerizable photosensitive layer was formed. The measurement of contact angle involved automated dynamic contact angle meter CA-W manufactured by Kyowa Interface Science Co., Ltd. The measurement conditions were such that a 1.5 μl water droplet was dropped onto the measurement sample at room temperature, and the angle after 500 msec from the landing was measured by the three-point plotting method (the θ/2 method). The measurement was repeated 5 times, and the average was obtained. A larger change in contact angle was interpreted as strongly indicating the remaining of the photosensitive layer component, and a smaller change in the values was understood to show excellent wash-off properties.

### Example 9

A negative photosensitive lithographic printing plate was obtained in the same manner as in Example 1, except that the gelatin: GEL type I used in the hydrophilic layer-coating liquid 1 of Example 1 was changed to gelatin: Gel type H (an alkali-treated gelatin from beef bone ossein: a mixture of first to third gelatin extracts). The obtained negative photosensitive lithographic printing plate was photoexposed, developed and evaluated in the same manner as in Example 8. The results are described in Table 2.

### Example 10

A negative photosensitive lithographic printing plate was obtained in the same manner as in Example 1, except that the gelatin: GEL type I used in the hydrophilic layer-coating liquid 1 of Example 1 was changed to gelatin: Gel type III (an alkali-treated gelatin from beef bone ossein: a mixture of second to fourth gelatin extracts). The obtained negative photosensitive lithographic printing plate was photoexposed, developed and evaluated in the same manner as in Example 8. The results are described in Table 2.

### Example 11

A negative photosensitive lithographic printing plate was obtained in the same manner as in Example 1, except that GEL type I used in the hydrophilic layer-coating liquid 1 of Example 1 was changed to Gel type IV (an alkali-treated gelatin from beef bone ossein: a mixture of first and fifth gelatin extracts). The obtained negative photosensitive lithographic printing plate was photoexposed, developed and evaluated in the same manner as in Example 8. The results are described in Table 2.

### Example 12

A negative photosensitive lithographic printing plate was obtained in the same manner as in Example 1, except that GEL type I used in the hydrophilic layer-coating liquid 1 of Example 1 was changed to Gel type V (an alkali-treated gelatin from beef bone ossein: a mixture of second and fourth gelatin extracts). The obtained negative photosensitive lithographic printing plate was photoexposed, developed and evaluated in the same manner as in Example 8. The results are described in Table 2.

TABLE 2

| | | | Wash-off properties | | | |
|---|---|---|---|---|---|---|
| | | | Non-image area contact angle | | | |
| | | | [°] | | | |
| | Gelatin in hydrophilic layer | | Before | | | |
| | Eluting | | formation of | After | Printing suitability | |
| | protein | Jelly | photosensitive | development | Plate | Scumming |
| | content [%] | strength [g] | layer | treatment | durability | resistance |
| Ex. 8 | 1.9 | 249 | 8.8 | 9.0 | ⊚ | ⊚ |
| Ex. 9 | 2.3 | 215 | 9.3 | 9.9 | ⊚ | ◯ |
| Ex. 10 | 2.8 | 188 | 12.0 | 13.8 | ◯ | Δ |
| Ex. 11 | 3.0 | 230 | 13.5 | 16.9 | ⊚ | X |
| Ex. 12 | 1.8 | 175 | 12.8 | 14.5 | ◯ | Δ |

From Table 2, it has been demonstrated that the lithographic printing plate supports and the negative photosensitive lithographic printing plates according to the invention achieved excellent wash-off properties when low-temperature development was adopted. When the negative photosensitive lithographic printing plates of Examples 9 to 12 were photoexposed and developed at a developer temperature of 25° C. similarly to Example 1, the obtained printing plates had practical printing suitability in terms of plate durability, scumming resistance, ink releasability and halftone staining resistance.

### Example 13

A hydrophilic layer was formed in the same manner as in Example 1, except that sodium polyoxyethylene nonylphenyl ether sulfate (10% solution) used as the surfactant in the hydrophilic layer-coating liquid 1 of Example 1 was changed to sodium polyoxyethylene tridecyl ether acetate (10% solution). The coating stability (uniformity at both ends) was evaluated by the following method. Further, a negative photosensitive lithographic printing plate was fabricated in the same manner as in Example 1, and the photoexposure and development treatment was carried out as described in Example 1. The obtained printing plate was subjected to the aforementioned evaluation of printing suitability in terms of scumming resistance, ink releasability and halftone staining resistance. In the evaluation of halftone staining resistance, the surface of the 2,000th printed sheet was also observed. Similar evaluations were performed with respect to Example 1. The results are described in Table 3.

[symbol] Coating Stability (Uniformity at Both Ends)

[symbol]

The surface of the coating composed of the hydrophilic layer in the above-obtained lithographic printing plate support was visually observed, and the coating stability was evaluated based on the following criteria. The results are described in Table 3. Even if the evaluation is not 0, the supports may be applied to practical use by removing the nonuniform portions.

⊚: The coating was free from nonuniform portions at both ends.

◯: The coating had nonuniform portions 5 mm to less than 15 mm in width at both ends.

Δ: The coating had nonuniform portions 15 mm to less than 30 mm in width at both ends.

x: The coating had nonuniform portions 30 mm or more in width at both ends.

### Example 14

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to sodium polyoxyethylene lauryl ether acetate (10% solution). The properties were evaluated in the same manner as in Example 13. The results are described in Table 3.

### Example 15

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to sodium octylphenoxy-polyethoxyacetate (10% solution). The properties were evaluated in the same manner as in Example 13. The results are described in Table 3.

### Example 16

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to polyoxyethylene tridecyl ether phosphate ester (10% solution). The properties were evaluated in the same manner as in Example 13. The results are described in Table 3.

### Example 17

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to disodium polyoxyethylenealkylsulfosuccinate (10% solution). The properties were evaluated in the same manner as in Example 13. The results are described in Table 3.

### Example 18

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to sodium polyoxyethylene lauryl ether phosphate (10% solution). The properties were evaluated in the same manner as in Example 13. The results are described in Table 3.

### Example 19

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to tripolyoxyethylene alkyl ether phosphate (10% solution). The properties were evaluated in the same manner as in Example 13. The results are described in Table 3.

TABLE 3

| | | | Halftone staining | | |
|---|---|---|---|---|---|
| | | | resistance | | |
| | Scumming | Ink | 2000th | 5000th | Coating stability |
| | resistance | releasability | sheet | sheet | (uniformity at both ends) |
| Ex. 1 | ⊚ | ⊚ | ◯ | ⊚ | Δ |
| Ex. 13 | ⊚ | ⊚ | ⊚ | ⊚ | ⊚ |
| Ex. 14 | ⊚ | ⊚ | ⊚ | ⊚ | ⊚ |
| Ex. 15 | ◯ | ◯ | Δ | ◯ | Δ |
| Ex. 16 | ⊚ | ◯ | ◯ | ⊚ | Δ |
| Ex. 17 | ◯ | ◯ | ◯ | ◯ | Δ |
| Ex. 18 | ⊚ | ◯ | ◯ | ⊚ | X |
| Ex. 19 | ◯ | ◯ | ◯ | ◯ | Δ |

From Table 3, it has been demonstrated that the invention makes it possible to obtain lithographic printing plate supports and negative photosensitive lithographic printing plates which achieve excellent coating stability (uniformity at both ends) as well as excellent properties in all of scumming resistance, halftone staining resistance and ink releasability.

### Example 20

A hydrophilic layer was formed in the same manner as in Example 1, except that sodium polyoxyethylene nonylphenyl ether sulfate (10% solution) used as the surfactant in the hydrophilic layer-coating liquid 1 of Example 1 was changed to coconut oil fatty acid amidopropyl dimethylhydroxysulfopropyl ammonium betaine (10% solution). The coating stability (cissing) was evaluated by the following method. Further, a negative photosensitive lithographic printing plate was fabricated in the same manner as in Example 1, and the photoexposure and development treatment was carried out as described in Example 1. The obtained printing plate was subjected to the evaluation of printing suitability in terms of the aforementioned plate durability and scumming resistance as well as in terms of the following inking properties. Similar evaluations were performed with respect to Example 1. The results are described in Table 4.

[symbol] Coating Stability (Cissing)

[symbol]

The surface of the coating composed of the hydrophilic layer was visually observed, and the coating stability was evaluated based on the following criteria. Even if the evaluation is x, the supports may be applied to practical use by removing the uncoated portions.

⊚: The surface of the coating was free from cissing.

x: Cissing was present on the surface of the coating.

[symbol] Inking Properties

[symbol]

The inking properties were evaluated based on the following criteria by counting the number of sheets printed until the image areas came to have a proper density from the start of the printing in the above plate durability test. The symbol x indicates that the printing plate is unusable in practical applications.

⊚: A proper density was obtained after less than 20 impressions.

◯: A proper density was obtained after 20 to less than 30 impressions.

Δ: A proper density was obtained after 30 to less than 50 impressions.

x: A proper density was obtained after 50 or more impressions.

### Example 21

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to coconut oil fatty acid amidopropyl betaine (10% solution). The properties were evaluated in the same manner as in Example 20. The results are described in Table 4.

### Example 22

A hydrophilic layer, a negative photosensitive lithographic printing plate and a printing plate were produced in the same manner as in Example 1, except that sodium polyoxyethylene nonylphenyl ether sulfate (10% solution) used as the surfactant in the hydrophilic layer-coating liquid 1 of Example 1 was changed to lauryl dimethylaminoacetic acid betaine (10% solution). The properties were evaluated in the same manner as in Example 20. The results are described in Table 4.

TABLE 4

| | Printing suitability | | | |
|---|---|---|---|---|
| | Plate | Scumming | Inking | Coating stability |
| | durability | resistance | properties | (cissing) |
| Ex. 1 | ⊚ | ⊚ | ○ | X |
| Ex. 20 | ⊚ | ⊚ | ⊚ | ⊚ |
| Ex. 21 | ⊚ | ⊚ | ⊚ | ⊚ |
| Ex. 22 | ○ | ⊚ | ○ | ⊚ |

From Table 4, it has been demonstrated that the invention makes it possible to obtain lithographic printing plate supports and negative photosensitive lithographic printing plates which exhibit excellent coating stability (cissing) to prevent the occurrence of cissing and which achieve excellent properties in all of plate durability, scumming resistance and inking properties.

### Example 23

A surface treatment liquid 1 described below was applied to the hydrophilic layer of Example 1 by a dipping method. The excess of the surface treatment liquid 1 was blown off with an air knife, and the coating was dried with dry wind controlled at 50° C. After the drying, the film was heat treated for 7 days in a thermo-hygrostat chamber controlled at 40° C. and 40% RH. Immediately after the excess liquid was blown off with an air knife, the amount of the surface treatment liquid attached to the surface was measured with an optical moisture meter to be about 3 g/m². From the amount of the liquid attached, the amount of impregnation of sugar alcohol was calculated to be 90 mg/m².

[symbol] Surface Treatment Liquid 1

[symbol]

| | |
|---|---|
| Water | 97 parts |
| Sorbitol | 3 parts |

Further, a negative photosensitive lithographic printing plate was fabricated in the same manner as in Example 1, and the photoexposure and development treatment was carried out as described in Example 1. With the obtained printing plate, the following evaluation of the strength of the image portion was performed. Furthermore, the printing plate was subjected to the evaluation of printing suitability in terms of the aforementioned scumming resistance similarly to Example 1 as well as in terms of the following plate durability (15,000 impressions). Similar evaluations were performed with respect to Example 1. The results are described in Table 5.

[symbol] Strength of Image Portion

[symbol]

The printing plate obtained above was soaked in ion exchange water at 25° C. for 30 seconds. Thereafter, the surface of the image portion was rubbed with absorbent cotton back and forth ten times, and was evaluated based on the following criteria. The symbols Δ and x indicate that the printing plate is unusable in practical applications.

⊚: The surface of the image portion was unchanged from before the rubbing.

◯: Slight flaws and rub marks were present.

Δ: Less than 50% of the image portion had disappeared.

x: 50% or more of the image portion had disappeared.

[symbol] Plate Durability (15,000 Impressions)

[symbol]

Printing was performed with use of offset sheet-fed printer Heidelberg QM46 as the printer, New Champion F-Gloss Black H manufactured by DIC Corporation as the printing ink, and a 1% dilute solution of ASTRO MARK III manufactured by NIKKEN CHEMICAL LABORATORY CO., LTD. as the fountain solution. The cylinder gap was changed from standard 200 μm to 300 μm (+100 μm) with a gauge film. The evaluation was made by comparing to each other the surface of the first printed sheet and the surface of the 15,000th printed sheet. Specifically, the printed sheets were carefully inspected with a 25× loupe for attenuation in 5-20% highlight halftone dot sections as well as abnormalities such as minute defects on solid sections. The plate durability was evaluated based on the following criteria. The symbol x indicates that the printing plate is unusable in practical applications.

⊚: Substantially no changes were found in the highlight sections and the solid sections.

◯: Slight attenuation (attenuation rate: within 10%) was observed in the highlight sections, but no defects were found in the solid sections.

Δ: Clear attenuation (attenuation rate: 10% or more) was observed in the highlight sections, but no defects were found in the solid sections.

x: Half or more of the highlight sections had been attenuated, or abnormalities such as defects were found in the solid sections.

### Example 24

A hydrophilic layer, a negative photosensitive lithographic printing plate and a printing plate were produced in the same manner as in Example 23, except that the surface treatment liquid 1 was changed to a surface treatment liquid 2 described below. The properties were evaluated in the same manner as in Example 23. The results are described in Table 5. The amount of the surface treatment liquid attached to the surface was measured with an optical moisture meter to be about 3 g/m². From the amount of the liquid attached, the amount of impregnation of sugar alcohol was calculated to be 90 mg/m².

[symbol] Surface Treatment Liquid 2

[symbol]

| | |
|---|---|
| Water | 97 parts |
| Xylitol | 3 parts |

### Example 25

A hydrophilic layer, a negative photosensitive lithographic printing plate and a printing plate were produced in the same manner as in Example 23, except that the surface treatment liquid 1 was changed to a surface treatment liquid 3 described below. The properties were evaluated in the same manner as in Example 23. The results are described in Table 5. The amount of the surface treatment liquid attached to the surface was measured with an optical moisture meter to be about 3 g/m². From the amount of the liquid attached, the amount of impregnation of sugar alcohol was calculated to be 24 mg/m².

[symbol] Surface Treatment Liquid 3

[symbol]

| | |
|---|---|
| Water | 99.2 parts |
| Sorbitol | 0.8 parts |

### Example 26

A hydrophilic layer, a negative photosensitive lithographic printing plate and a printing plate were produced in the same manner as in Example 1, except that 0.1 part of sorbitol was added to the hydrophilic layer-coating liquid 1 of Example 1. The properties were evaluated in the same manner as in Example 23. The results are described in Table 5. The content of sugar alcohol in the hydrophilic layer was calculated by multiplying the wet mass of the applied hydrophilic layer-coating liquid by the proportion of the sugar alcohol, resulting in 100 mg/m².

TABLE 5

| | Strength of image | Plate durability | Scumming |
|---|---|---|---|
| | portion | (15,000 impressions) | resistance |
| Ex. 1 | ○ | Δ | ⊚ |
| Ex. 23 | ⊚ | ⊚ | ⊚ |
| Ex. 24 | ⊚ | ⊚ | ⊚ |
| Ex. 25 | ⊚ | ○ | ⊚ |
| Ex. 26 | ○ | ○ | ⊚ |

From Table 5, it has been demonstrated that the invention makes it possible to obtain lithographic printing plate supports and negative photosensitive lithographic printing plates which exhibit excellent strength of the image portion after development and which achieve excellent printing suitability. A separate evaluation according to the procedures described in Example 1 also showed that the negative photosensitive lithographic printing plates of Examples 23 to 26 had practical printing suitability in terms of plate durability, ink releasability and halftone staining resistance.

### Example 27

A surface treatment liquid 4 described below was applied to the hydrophilic layer of Example 1 by a dipping method. The excess of the surface treatment liquid 4 was blown off with an air knife, and the coating was dried with dry wind controlled at 50° C. After the drying, the film was heat treated for 7 days in a thermo-hygrostat chamber controlled at 40° C. and 40% RH. The amount of the polymer compound having a polymerizable double bond group that was present on the hydrophilic layer by this surface treatment was 90 mg/m².

[symbol] Surface Treatment Liquid 4

[symbol]

| | |
|---|---|
| Water | 97 parts |
| Sulfonic acid polymer SP-1 (weight average | 3 parts |
| molecular weight 300,000) | |

Further, a negative photosensitive lithographic printing plate was fabricated in the same manner as in Example 1, and the photoexposure and development treatment was carried out as described in Example 1. The obtained printing plate was subjected to the evaluation of plate durability (15,000 impressions) in the same manner as in Example 23 and also to the evaluation of printing suitability in terms of scumming resistance, ink releasability and halftone staining resistance in the same manner as in Example 1. Similar evaluations were performed with respect to Example 1. The results are described in Table 6.

### Example 28

A hydrophilic layer, a negative photosensitive lithographic printing plate and a printing plate were produced in the same manner as in Example 27, except that the surface treatment liquid 4 was changed to a surface treatment liquid 5 described below. The properties were evaluated in the same manner as in Example 27. The results are described in Table 6. The amount of the polymer compound having a polymerizable double bond group that was present on the hydrophilic layer by the surface treatment was 90 mg/m².

[symbol] Surface Treatment Liquid 5

[symbol]

| | |
|---|---|
| Water | 97 parts |
| Sulfonic acid polymer SP-2 (weight average | 3 parts |
| molecular weight 400,000) | |

### Example 29

A hydrophilic layer, a negative photosensitive lithographic printing plate and a printing plate were produced in the same manner as in Example 27, except that the surface treatment liquid 4 was changed to a surface treatment liquid 6 described below.

The properties were evaluated in the same manner as in Example 27. The results are described in Table 6. The amount of the polymer compound having a polymerizable double bond group that was present on the hydrophilic layer by the surface treatment was 25 mg/m².

[symbol] Surface Treatment Liquid 6

[symbol]

| | |
|---|---|
| Water | 99.2 parts |
| Quaternary ammonium group-containing polymer CP-2 | 0.8 parts |
| (weight average molecular weight 350,000) | |

### Example 30

A hydrophilic layer, a negative photosensitive lithographic printing plate and a printing plate were produced in the same manner as in Example 1, except that 0.09 parts of sulfonic acid polymer SP-1 (weight average molecular weight 300,000) was added to the hydrophilic layer-coating liquid 1 of Example 1. The properties were evaluated in the same manner as in Example 27. The results are described in Table 6. The amount of the polymer compound having a polymerizable double bond group that was present in the hydrophilic layer was 90 mg/m².

TABLE 6

| | Plate durability | Scumming | Ink | Halftone staining |
|---|---|---|---|---|
| | (15,000 impressions) | resistance | releasability | resistance |
| Ex. 1 | Δ | ⊚ | ⊚ | ⊚ |
| Ex. 27 | ⊚ | ⊚ | ⊚ | ⊚ |
| Ex. 28 | ⊚ | ⊚ | ⊚ | ⊚ |
| Ex. 29 | ⊚ | ⊚ | ⊚ | ⊚ |
| Ex. 30 | Δ | ⊚ | ⊚ | ⊚ |

From Table 6, it has been demonstrated that the invention makes it possible to obtain lithographic printing plate supports and negative photosensitive lithographic printing plates which achieve excellent properties in all of plate durability, scumming resistance, ink releasability and halftone staining resistance.

1. A lithographic printing plate support comprising a hydrophilic layer on a substrate, the hydrophilic layer containing an inorganic filler and a hydrophilic binder, the inorganic filler in the hydrophilic layer having particle size distribution peaks in the range of 0.2 μm to less than 0.6 μm and in the range of 0.6 μm to less than 1.5 μm.

2. The lithographic printing plate support according to claim 1, wherein a fx/fy ratio is not less than 1.5 wherein fx is the distribution frequency of the inorganic filler in the range of 0.2 μm to less than 0.6 μm and fy is the distribution frequency of the inorganic filler in the range of 0.6 μm to less than 1.5 μm, and wherein the distribution frequency fy is not less than 25%.

3. The lithographic printing plate support according to claim 2, wherein the fx/fy ratio is not less than 2.

4. The lithographic printing plate support according to claim 1, wherein the inorganic filler is at least one selected from titanium dioxide, barium sulfate and aluminum hydroxide.

5. The lithographic printing plate support according to claim 4, wherein the inorganic fillers include two or more selected from titanium dioxide, barium sulfate and aluminum hydroxide.

6. The lithographic printing plate support according to claim 5, wherein the inorganic fillers include all three of titanium dioxide, barium sulfate and aluminum hydroxide.

7. The lithographic printing plate support according to claim 1, wherein the hydrophilic binder is gelatin having an eluting protein content of not more than 2.5 mass % and a jelly strength of not less than 200 g.

8. The lithographic printing plate support according to claim 7, wherein the eluting protein content is not more than 2.0 mass %.

9. The lithographic printing plate support according to claim 7, wherein the jelly strength is not less than 225 g.

10. The lithographic printing plate support according to claim 1, wherein the hydrophilic layer contains a surfactant.

11. The lithographic printing plate support according to claim 10, wherein the surfactant is a polyoxyethylene alkyl ether acetate salt.

12. The lithographic printing plate support according to claim 10, wherein the surfactant is an amphoteric surfactant.

13. The lithographic printing plate support according to claim 12, wherein the amphoteric surfactant is a fatty acid alkyl betaine surfactant.

14. The lithographic printing plate support according to claim 1, wherein the hydrophilic layer contains a sugar alcohol.

15. The lithographic printing plate support according to claim 1, wherein the hydrophilic layer is a hydrophilic layer surface-treated with a polymer compound having a polymerizable double bond group.

16. A negative photosensitive lithographic printing plate comprising at least a photopolymerizable photosensitive layer on the hydrophilic layer of the lithographic printing plate support described in claim 1.
